(19) United States
(12) Patent Application Publication
(10) Pub. No.: US 2012/0083309 A1
(43) Pub. Date: Apr. 5, 2012

(54) APPARATUS AND METHOD FOR TRANSMITTING CONTROL INFORMATION FOR POWER COORDINATION IN MULTIPLE COMPONENT CARRIER SYSTEM

(75) Inventors: Ki Bum KWON, Ansan-si (KR); Myung Cheul JUNG, Seoul (KR); Jae Hyun AHN, Seongnam-si (KR)

(73) Assignee: PANTECH CO., LTD., Seoul (KR)

(21) Appl. No.: 13/250,249

(22) Filed: Sep. 30, 2011

(30) Foreign Application Priority Data
Oct. 1, 2010 (KR) 10-2010-0096117

(51) Int. Cl. H04W 52/04

(52) U.S. Cl. 455/522

(57) ABSTRACT

An apparatus and method for transmitting control information about power coordination in a multiple component carrier system is disclosed herein. This specification discloses receiving information about a mobile station which is used to determine a range of power coordination for a maximum uplink transmit power of the mobile station, from a base station, by obtaining the information, and transmitting an information response message to the base station, which includes the obtained subsidiary information. Further, compatibility with an existing system may be accomplished due to information about power coordination being provided through the use of an existing UE information procedure.

### CROSS-REFERENCE TO RELATED APPLICATION

This application claims priority from and the benefit under 35 U.S.C. §119(a) of Korean Patent Application 10-2010-0096117, filed on Oct. 1, 2010, which is hereby incorporated by reference for all purposes as if fully set forth herein.

### BACKGROUND

1. Field

This disclosure relates to wireless communication, and particularly, to an apparatus and method for transmitting information about power coordination in a multiple component carrier system.

2. Discussion of the Background

Candidates of the next-generation wireless communication system, such as 3^{rd} Generation Partnership Project (3GPP) Long Term Evolution (LTE) and Institute of Electrical and Electronics Engineers (IEEE) 802.16m are being developed. The IEEE 802.16m standard involves two aspects, a change to the existing IEEE 802.16e standard and a standard for the next-generation IMT-Advanced system. Accordingly, the IEEE 802.16m standard fulfills all advanced requirements for the IMT-Advanced system while maintaining compatibility with a Mobile WiMAX system based on the IEEE 802.16e standard.

A wireless communication system uses bandwidth for data transmission. For example, the 2^{rd} generation wireless communication system uses a bandwidth of 200 KHz to 1.25 MHz, and the 3^{rd} generation wireless communication system uses a bandwidth of 5 MHz to 10 MHz. In order to support an increasing transmission capacity, the bandwidth of the recent 3GPP LTE or 802.16m is extended up to 20 MHz or higher. Increasing the bandwidth may be done in conjunction with the increase of transmission capacity to support a greater bandwidth; however, this may generate a large power consumption even though the required level of Quality of Service (QoS) is low.

Accordingly, a multi-component carrier system has been developed in which a component carrier having a bandwidth and the center frequency is defined, and data is transmitted or received in a wide band through a plurality of component carriers. That is, a narrow band and a wide band are supported at the same time by using one or more component carriers. For example, if one component carrier corresponds to a bandwidth of 5 MHz, a maximum of 20 MHz bandwidth can be supported by using four component carriers.

A method for a base station to efficiently utilize the resources of a mobile station has also been developed by using power information about the mobile station. A power control technique is a technique for minimizing interference factors and for reducing the battery consumption of a mobile station in order to efficiently distribute resources in a wireless communication. A mobile station may determine uplink transmit power based on Transmit Power Control (TPC) allocated by a base station, a Modulation and Coding Scheme (MCS), and scheduling information about the bandwidth, etc.

As a multiple component carrier system is introduced, the uplink transmit power of component carriers is generally taken into consideration. Accordingly, the power control of a mobile station becomes more complicated. Such complexity may cause problems in terms of a maximum transmit power of a mobile station. In general, a mobile station is operated by power lower than a maximum transmit power that is allowed. If a base station performs scheduling requiring a transmit power higher than the maximum transmit power, a problem may be caused in which an actual uplink transmit power exceeds the maximum transmit power. This is because power control for multiple component carriers has not been clearly defined or information about an uplink transmit power has not been sufficiently shared between a mobile station and a base station.

### SUMMARY

This disclosure is directed to an apparatus and method for transmitting control information about power coordination in a multiple component carrier system.

Additional features of the invention will be set forth in the description which follows, and in part will be apparent from the description, or may be learned by practice of the invention.

An exemplary embodiment provides a method of transmitting control information in a multiple component carrier system, the method including: receiving, by a user equipment (UE), a UE capability request message from a base station (BS); and transmitting, by the UE, a response message comprising UE capability information about the UE, to the BS, wherein the UE capability information includes: maximum combination information (maxBandComb) indicating all combinations supportable by the UE, from among combinations of specific frequency bands, information identifying an uplink operating frequency band and a downlink operating frequency band to allow communication between the UE and the BS, and a bandwidth class defining both the maximum number of component carriers supported by the UE and a frequency bandwidth formed by an aggregation of the supported component carriers.

An exemplary embodiment provides a method of receiving control information in a multiple component carrier system, the method including: transmitting, by a base station (BS), a UE capability request message to a user equipment (UE); and receiving, by the BS, a response message comprising UE capability information about the UE from the UE, wherein the UE capability information comprises: maximum combination information (maxBandComb) indicating all combinations supportable by the UE from among combinations of specific frequency bands, information identifying an uplink operating frequency band and a downlink operating frequency band to allow communication between the UE and the BS, and a bandwidth class that defines both the maximum number of component carriers supported by the UE and a frequency bandwidth formed by an aggregation of the supported component carriers.

An exemplary embodiment provides a user equipment (UE) to transmit control information in a multiple component system, the UE including: a message reception unit to receive a UE capability request message from a base station (BS); a subsidiary information acquisition unit to obtain UE capability information about the UE; and a message transmission unit to transmit a response message, comprising the UE capability information, to the BS, wherein the subsidiary information acquisition unit obtains the UE capability information which includes: maximum combination information (maxBandComb) indicating all combinations supportable by the UE from among combinations of specific frequency bands, information identifying an uplink operating frequency band and a downlink operating frequency band to allow communication between the UE and the BS, and a bandwidth class defining both the maximum number of component carriers supported by the UE and a frequency bandwidth formed by an aggregation of the supported component carriers.

An exemplary embodiment provides a base station (BS) to receive control information in a multiple component carrier system, the BS including: a message transmission unit to transmit a user equipment (UE) capability request message to a UE; and a message reception unit to receive, from the UE, a response message comprising UE capability information about the UE, wherein the UE capability information includes: maximum combination information (maxBandComb) indicating all combinations supportable by the UE, from among combinations of specific frequency bands, information identifying an uplink operating frequency band and a downlink operating frequency band to allow communication between the UE and the BS, and a bandwidth class defining both the maximum number of component carriers supported by the UE and a frequency bandwidth formed by an aggregation of the supported component carriers.

An exemplary embodiment provides a method of transmitting control information in a multiple component carrier system, the method comprising: receiving, at a user equipment (UE), a UE capability request message from a Base Station (BS), and transmitting, at the UE, a UE capability response message, including UE characteristic information, to the BS.

The UE characteristic information comprises information on the number of frequency bands simultaneously supportable by the UE, information on each of the frequency bands, information on a maximum number of component carriers supportable by the UE in each of the frequency bands, and information on a frequency bandwidth supportable by an aggregation within the maximum number of the component carriers.

A total number calculated by adding the maximum number of the component carriers for all of the frequency bands, is smaller than or equal to a total number of component carriers supportable by the UE.

The maximum number of the component carriers and the frequency bandwidth for each of the frequency bands, are determined by a hardware construction of the UE.

An uplink band and a downlink band are subjected to frequency division within each of the frequency bands.

The maximum number of the component carriers is determined within n(n≧1).

An exemplary embodiment provides a method of receiving control information in a multiple component carrier system, the method comprising: transmitting, at a Base Station (BS), a UE capability request message to a user equipment (UE), and receiving, at the BS, a UE capability response message including UE characteristic information, from the UE.

The UE characteristic information comprises information on the number of frequency bands simultaneously supportable by the UE, information on each the frequency bands, information on a maximum number of component carriers supportable by the UE in each of the frequency bands, and information on a frequency bandwidth supportable by an aggregation within the maximum number of the component carriers.

A total number calculated by adding the maximum number of the component carriers for all of the frequency bands, is smaller than or equal to a total number of component carriers supportable by the UE.

The maximum number of the component carriers and the frequency bandwidth for each of the frequency bands, are determined by a hardware construction of the UE.

An uplink band and a downlink band are subjected to frequency division within each of the frequency bands.

The maximum number of the component carriers in each of the frequency bands is determined within n(n≧1).

An exemplary embodiment provides a user equipment (UE) to transmit control information in a multiple component system, the UE comprising: a message reception unit configured to receive a UE capability request message from a Base Station (BS), an information acquisition unit configured to analyze the UE capability request message and obtain UE characteristic information, and a message transmission unit configured to transmit a UE capability response message including the UE characteristic information, to the BS.

The UE characteristic information comprises information on the number of frequency bands simultaneously supportable by the UE, information on each the frequency bands, information on a maximum number of component carriers supportable by the UE in each of the frequency bands, and information on a frequency bandwidth supportable by an aggregation within the maximum number of the component carriers.

A total number calculated by adding the maximum number of the component carriers for all of the frequency bands, is smaller than or equal to a total number of component carriers supportable by the UE.

The maximum number of the component carriers and the frequency bandwidth for each of the frequency bands, are determined by a hardware construction of the UE.

An uplink band and a downlink band are subjected to frequency division within each of the frequency bands.

The maximum number of the component carriers in each of the frequency bands is determined within n(n≧1).

An exemplary embodiment provides a base station (BS) to receive control information in a multiple component carrier system, the method comprising: a message transmission unit configured to transmit, to a user equipment (UE), a UE capability request message, a message reception unit configured to receive, from the UE, a UE capability response message including UE characteristic information, in response to the UE capability request message, and a information analysis unit configured to determine the UE characteristic information.

The UE characteristic information comprises information on the number of frequency bands simultaneously supportable by the UE, information on each the frequency bands, information on a maximum number of component carriers supportable by the UE in each of the frequency bands, and information on a frequency bandwidth supportable by an aggregation within the maximum number of the component carriers.

A total number calculated by adding the maximum number of the component carriers for all of the frequency bands, is smaller than or equal to a total number of component carriers supportable by the UE.

The maximum number of the component carriers and the frequency bandwidth for each of the frequency bands, are determined by a hardware construction of the UE.

An uplink band and a downlink band are subjected to frequency division within each of the frequency bands.

The maximum number of the component carriers for each of the frequency bands is determined within n(n≧1).

An exemplary embodiment provides a method of transmitting control information in a multiple component carrier system, the method comprising: receiving, at a user equipment (UE), a UE capability request message from a Base Station (BS, and transmitting, at the UE, a UE capability response message, including UE characteristic information, to the BS.

The UE characteristic information comprises information about a first frequency band supportable by the UE, information indicating a first maximum number of component carriers supportable by the UE in the first frequency band, and information about a first frequency bandwidth supportable by an aggregation of component carriers within the first maximum number, and the UE characteristic information further comprises information about a second frequency band supportable by the UE, information indicating a second maximum number of component carriers supportable by the UE within the second frequency band, and information about a second frequency bandwidth supportable by an aggregation of component carriers within the second maximum number.

An exemplary embodiment provides a method of receiving control information in a multiple component carrier system, the method comprising: transmitting, at a Base Station (BS) a UE capability request message to a user equipment (UE), and receiving, at the BS, a UE capability response message, including UE characteristic information, from the UE.

The UE characteristic information comprises information about a first frequency band supportable by the UE, information indicating a first maximum number of component carriers supportable by the UE in the first frequency band, and information about a first frequency bandwidth supportable by an aggregation of component carriers within the first maximum number, and the UE characteristic information further comprises information about a second frequency band supportable by the UE, information indicating a second maximum number of component carriers supportable by the UE within the second frequency band, and information about a second frequency bandwidth supportable by an aggregation of component carriers within the second maximum number.

An exemplary embodiment provides a user equipment (UE) to transmit control information in a multiple component system, the UE comprising: a message reception unit configured to receive, a UE capability request message from a Base Station (BS), a information acquisition unit configured to obtain UE characteristic information, and a message transmission unit configured to transmit, a UE capability response message, including the UE characteristic information, to the BS.

The UE characteristic information comprises information about a first frequency band supportable by the UE, information indicating a first maximum number of component carriers supportable by the UE in the first frequency band, and information about a first frequency bandwidth supportable by an aggregation of component carriers within the first maximum number, and the UE characteristic information further comprises information about a second frequency band supportable by the UE, information indicating a second maximum number of component carriers supportable by the UE within the second frequency band, and information about a second frequency bandwidth supportable by an aggregation of component carriers within the second maximum number.

An exemplary embodiment provides a base station (BS) to receive control information in a multiple component carrier system, the method comprising: a message transmission unit configured to transmitting, a UE capability request message to a user equipment (UE), a message reception unit configured to receive, a UE capability response message, including UE characteristic information, from the UE, and an information analysis unit configured to determine the UE characteristic information.

The UE characteristic information comprises information about a first frequency band supportable by the UE, information indicating a first maximum number of component carriers supportable by the UE in the first frequency band, and information about a first frequency bandwidth supportable by an aggregation of component carriers within the first maximum number, and the UE characteristic information further comprises information about a second frequency band supportable by the UE, information indicating a second maximum number of component carriers supportable by the UE within the second frequency band, and information about a second frequency bandwidth supportable by an aggregation of component carriers within the second maximum number.

An exemplary embodiment provides a method of transmitting control information, in a multiple component carrier system, the method comprising: receiving, at User Equipment (UE), a UE capability request message from a Base Station (BS), and transmitting, at the UE, a UE capability response message, including a UE characteristic information set, to the BS.

The UE characteristic information set comprises information about a frequency band supportable by the UE, information about a maximum number of component carriers supportable by the UE in the frequency band, and information about a frequency bandwidth supportable by an aggregation of component carriers within the maximum number of component carriers, and the number of UE characteristic information sets equals to the number of frequency bands simultaneously supportable by the UE.

An exemplary embodiment provides a method of receiving control information in a multiple component carrier system, the method comprising: transmitting, at a Base Station (BS) a UE capability request message to a user equipment (UE), and receiving, at the BS, a UE capability response message, including a UE characteristic information set, from the UE.

The UE characteristic information set comprises information about a frequency band supportable by the UE, information about a maximum number of component carriers supportable by the UE in the frequency band, and information about a frequency bandwidth supportable by the UE through an aggregation of component carriers within the maximum number of component carriers, and the number of UE characteristic information sets equals to the number of frequency bands simultaneously supportable by the UE.

An exemplary embodiment provides a user equipment (UE) to transmit control information in a multiple component system, the UE comprising: a message reception unit configured to receive, a UE capability request message from a Base Station (BS), an information acquisition unit configured to obtain a UE characteristic information set, and a message transmission unit configured to transmit, a UE capability response message, including the UE characteristic information set, to the BS.

The UE characteristic information set comprises information about a frequency band supportable by the UE, information about a maximum number of component carriers supportable by the UE in the frequency band, and information about a frequency bandwidth supportable by an aggregation of component carriers within the maximum number of component carriers, and the number of UE characteristic information sets equals to the number of frequency bands simultaneously supportable by the UE.

An exemplary embodiment provides a base station (BS) to receive control information in a multiple component carrier system, the method comprising: a message transmission unit configured to transmitting, a UE capability request message to a user equipment (UE), a message reception unit configured to receive, a UE capability response message, including a UE characteristic information set, from the UE, and an information analysis unit configured to determine the UE characteristic information set.

The UE characteristic information set comprises information about a frequency band supportable by the UE, information about a maximum number of component carriers supportable by the UE in the frequency band, and information about a frequency bandwidth supportable by an aggregation of component carriers within the maximum number of component carriers, and the number of UE characteristic information sets equals to the number of frequency bands simultaneously supportable by the UE.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a wireless communication system according to an exemplary embodiment.

FIG. 2 is an explanatory diagram illustrating an intra-band contiguous carrier aggregation according to an exemplary embodiment.

FIG. 3 is an explanatory diagram illustrating an intra-band non-contiguous carrier aggregation according to an exemplary embodiment.

FIG. 4 is an explanatory diagram illustrating an inter-band carrier aggregation according to an exemplary embodiment.

FIG. 5 shows a link between a DL CC (downlink component carrier) and a UL CC (uplink component carrier) in a multiple carrier system according to an exemplary embodiment.

FIG. 6 is a graph showing an example of Power Headroom (PH), which is applied in the time-frequency axis according to an exemplary embodiment.

FIG. 7 is a graph showing another example of PH, which is applied in the time-frequency axis according to an exemplary embodiment.

FIG. 8 is a conceptual diagram illustrating the influence of uplink scheduling of a base station on the transmit power of a mobile station in a wireless communication system according to an exemplary embodiment.

FIG. 9 is an explanatory diagram illustrating the power coordination amount and the maximum transmit power in a multiple component carrier system according to an exemplary embodiment.

FIG. 10 is an explanatory diagram illustrating subsidiary information according to an exemplary embodiment.

FIG. 11 is an explanatory diagram illustrating subsidiary information according to an exemplary embodiment.

FIG. 12 is an explanatory diagram illustrating subsidiary information according to an exemplary embodiment.

FIG. 13 shows a flow illustrating a method of transmitting control information about power coordination according to an exemplary embodiment.

FIG. 14 shows a flow illustrating a method of transmitting control information about power coordination according to an exemplary embodiment.

FIG. 15 is a flowchart illustrating a method of a mobile station transmitting control information about power coordination according to an exemplary embodiment.

FIG. 16 is a flowchart illustrating a method of a base station transmitting control information about power coordination according to an exemplary embodiment.

FIG. 17 is a flowchart illustrating a method of setting scheduling parameters based on information about power coordination according to an exemplary embodiment.

FIG. 18 is a block diagram showing a mobile station and a base station in a multiple component carrier system according to an exemplary embodiment.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Further, in this disclosure, a wireless communication network is described. Tasks performed in the wireless communication network may be performed in a system (for example, a base station), such as a system for managing the wireless communication network or a system for controlling the network and transmitting data, or the tasks may be performed by a mobile station coupled to a network.

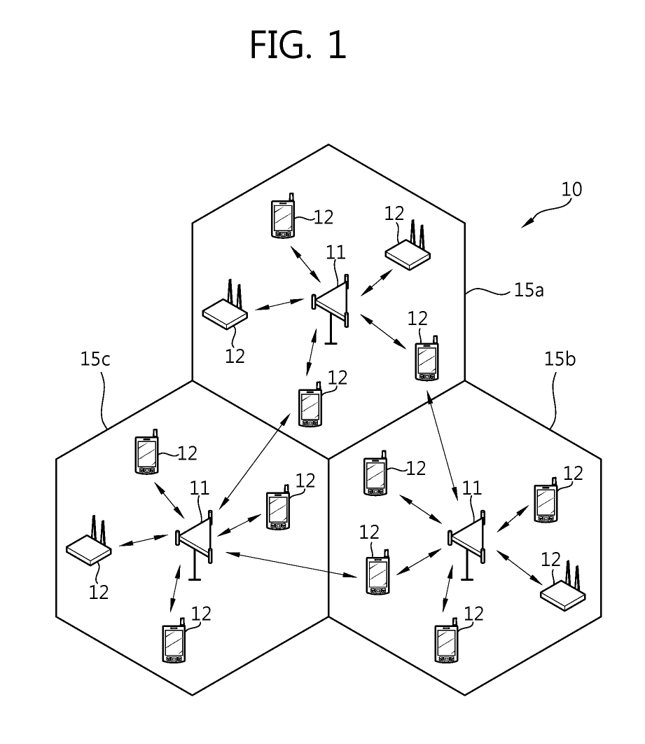

FIG. 1 shows a wireless communication system according to an exemplary embodiment.

Referring to FIG. 1, the wireless communication systems 10 are deployed in order to provide a variety of communication services, such as voice and packet data transmission.

The wireless communication system 10 includes one or more Base Stations (BS) 11 (three are shown). Each BS 11 provides communication services to specific geographical areas (typically called cells) 15a, 15b, and 15c. The cell may be further classified into a plurality of areas (called sectors).

A user equipment (UE) 12 may be a fixed or mobile device and may also be referred to with other terminology, such as a Mobile Station(MS), a Mobile Terminal (MT), a User Terminal (UT), Subscriber Station(SS), a wireless device, a Personal Digital Assistant (PDA), a wireless modem, a handheld device, or the like.

The BS 11 refers to a fixed station that communicates with each one of the various UE 12, and may also be referred to with other terminology, such as eNodeB (evolved NodeB: eNB), a BTS (Base Transceiver System), or an access point. The cell may be interpreted as indicating some area covered by the BS 11. Various coverage areas of the cell may be used, such as a mega cell, a macro cell, a micro cell, a pico cell, and a femto cell.

Hereinafter, downlink (DL) refers to communication from the BS 11 to the UE 12, and uplink (UL) refers to communication from the UE 12 to the BS 11. In this case, in a downlink, a transmitter may be part of the BS 11, and a receiver may be part of the UE 12. Further, in uplink, a transmitter may be part of the UE 12, and a receiver may be part of the BS 11. In some cases, downlink may refer to communication from the UE 12 to the BS 11, and uplink may refer to communication from the BS 11 to the UE 12. In this case, in downlink, a transmitter may be part of the UE 12, and a receiver may be part of the BS 11. Further, in uplink, a transmitter may be part of the BS 11, and a receiver may be part of the UE 12.

A variety of multiple access schemes, such as CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, and OFDM-CDMA, may be used with a wireless communication system. In uplink transmission and downlink transmission, a TDD (Time Division Duplex) scheme in which the transmission is performed using different times may be used or an FDD (Frequency Division Duplex) scheme in which the transmission is performed using different frequencies may be used.

The layers of a radio interface protocol between a UE and a network may be classified into a first layer L1, a second layer L2, and a third layer L3 on the basis of three lower layers of an Open System Interconnection (OSI), the OSI being known in the communication systems.

A physical layer (i.e., the first layer) is connected to a higher Medium Access Control (MAC) layer through a transport channel. Data between the MAC layer and the physical layer is moved through the transport channel. Further, data between different physical layers (i.e., the physical layers on the transmission side and on the reception side) is moved through a physical channel. There are some control channels that are available to be used in the physical layer. A Physical Downlink Control Channel (PDCCH) through which physical control information is transmitted informs a UE of the resource allocation of a PCH (paging channel) and a downlink shared channel (DL-SCH) and of Hybrid Automatic Repeat Request (HARQ) information related to the DL-SCH. The PDCCH may carry an uplink grant, informing a UE of the resource allocation of uplink transmission. A Physical Control Format Indicator Channel (PCFICH) is used to inform a UE of the number of OFDM symbols used in the PDCCHs and is transmitted for every frame. A Physical Hybrid ARQ Indicator Channel (PHICH) carries HARQ ACK/NAK signals in response to uplink transmission. A Physical Uplink Control Channel (PUCCH) carries the HARQ ACK/NAK signals for downlink transmission, a scheduling request, and uplink control information, such as Channel Quality Information (CQI). A Physical Uplink Shared Channel (PUSCH) carries a UL-SCH (uplink shared channel).

A situation in which a UE transmits the PUCCH or the PUSCH is described below.

A UE configures a PUCCH for one or more pieces of information about CQI, a PMI (Precoding Matrix Index) selected based on measured space channel information, and a Rank Indicator (RI) periodically transmits the configured PUCCH to a BS. Further, the UE transmits information about ACK/NACK (Acknowledgement/non-Acknowledgement) for downlink data to a BS after a certain number of sub-frames after receiving the downlink data. For example, if the downlink data is received in an n^{th} subframe, the UE transmits a PUCCH, composed of ACK/NACK information about the downlink data, in an (n+4)^{th} subframe. If all the pieces of ACK/NACK information cannot be transmitted on a PUCCH allocated by a BS or if a PUCCH on which ACK/NACK information can be transmitted is not allocated by a BS, a UE may carry the ACK/NACK information on a PUSCH.

A radio data link layer (i.e., the second layer) includes a MAC layer, an RLC layer, and a PDCP layer. The MAC layer is a layer responsible for mapping between a logical channel and a transport channel. The MAC layer selects a proper transport channel suitable for sending data received from the RLC layer and adds control information to the header of an MAC PDU (Protocol Data Unit). The RLC layer is placed over the MAC layer and configured to support reliable data transmission. Further, the RLC layer segments and concatenates RLC Service Data Units (SDUs) received from a higher layer in order to configure data to have a size suitable for a radio section. The RLC layer of a receiver supports a data reassembly function for recovering original RLC SDUs from received RLC PDUs. The PDCP layer is used only in a packet exchange region, and it can compress and send the header of an IP packet in order to increase the transmission efficiency of packet data in a radio channel.

A RRC layer (i.e., the third layer) functions to control a lower layer and also to exchange pieces of radio resource control information between a UE and a network. A variety of RRC states, such as an idle mode and an RRC connected mode, are defined according to the communication state of a UE. A UE may transfer between the various RRC states. Various procedures related to the management of radio resources, such as system information broadcasting, a RRC access management procedure, a multiple component carrier configuration procedure, a radio bearer control procedure, a security procedure, a measurement procedure, and a mobility management procedure (handover), may be defined in the RRC layer.

A carrier aggregation (CA) supports a plurality of carriers. The carrier aggregation may also be referred to as a spectrum aggregation or a bandwidth aggregation. An individual unit carrier aggregated by the carrier aggregation is called a Component Carrier (CC). Each CC is defined by the bandwidth and the center frequency. The carrier aggregation is introduced to support an increased throughput, prevent an increase of the costs due to the introduction of wideband RF (radio frequency) devices, and provide compatibility with the existing system. For example, if five CCs are allocated as the granularity of a carrier unit having a 5 MHz bandwidth, a maximum bandwidth of 20 MHz can be supported.

CCs may be divided into a primary CC (hereinafter referred to as a PCC) and a secondary CC (hereinafter referred to as a SCC) based on whether they have been activated. The PCC is a carrier that is always remains activated, and the SCC is a carrier that is activated or deactivated according to a specific condition. The term ‘activation’ refers to the transmission or reception of traffic data is being performed or is in a standby state. The term ‘deactivation’ refers to the transmission or reception of traffic data is impossible, but measurement or the transmission/reception of minimum information is possible. A UE may use one PCC and one or more SCCs along with a PCC. A BS may allocate the PCC or the SCC or both to a UE.

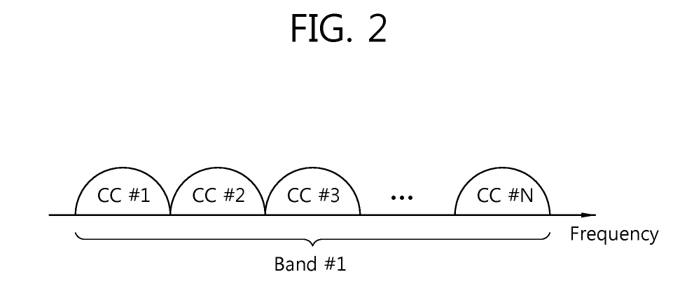

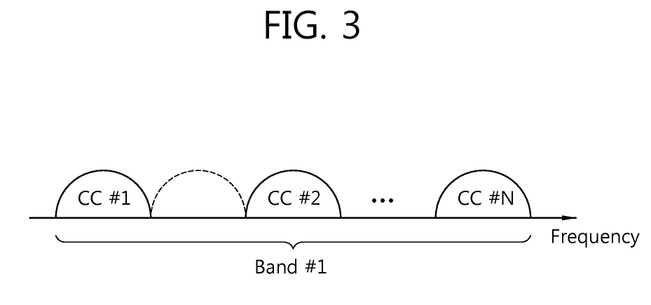

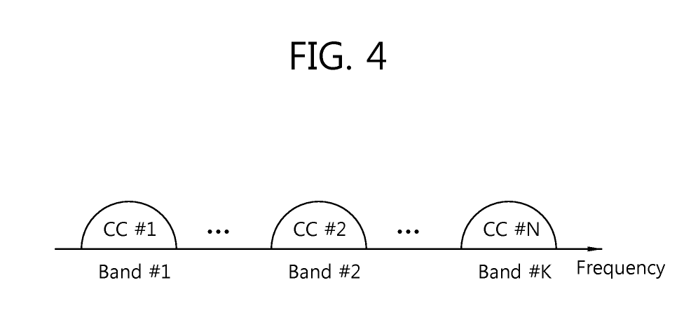

The carrier aggregation may be classified according to an exemplary embodiment into an intra-band contiguous carrier aggregation, such as that shown in FIG. 2, an intra-band non-contiguous carrier aggregation, such as that shown in FIG. 3, and an inter-band carrier aggregation, such as that shown in FIG. 4.

First, referring to FIG. 2, the intra-band contiguous carrier aggregation is formed between continuous CCs in the same band. For example, aggregated CCs, CC#1, CC#2, CC#3 to CC #N, are contiguous with each other.

Referring to FIG. 3, the intra-band non-contiguous carrier aggregation is formed between discontinuous CCs. For example, aggregated CCs, CC#1 and CC#2 are spaced apart from each other by a specific frequency.

Referring to FIG. 4, the inter-band carrier aggregation is of a type in which, if a plurality of CCs exists, one or more of the CCs are aggregated on different frequency bands. For example, an aggregated CC, CC #1 exists in a band #1, and an aggregated CC, CC #2 exists in a band #2.

The number of carriers aggregated in downlink and the number of carriers aggregated in uplink may be set differently. A case where the number of DL CCs is identical with the number of UL CCs is called a symmetric aggregation, and a case where the number of DL CCs is different from the number of UL CCs is called an asymmetric aggregation.

Further, CCs may have different sizes (i.e., bandwidths). For example, assuming that 5 CCs are used to configure a 70 MHz band, the configuration of the 70 MHz band may be a 5 MHz CC (carrier #0)+a 20 MHz CC (carrier #1)+a 20 MHz CC (carrier #2)+a 20 MHz CC (carrier #3)+a 5 MHz CC (carrier #4).

A multiple carrier system hereinafter refers to a system supporting the carrier aggregation. In the multiple carrier system, the contiguous carrier aggregation or the non-contiguous carrier aggregation or both may be used. Further, either a symmetric aggregation or an asymmetric aggregation may be used.

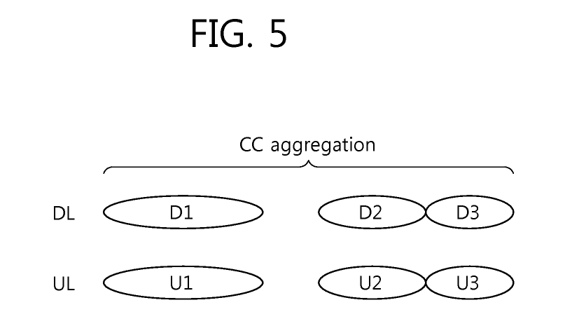

FIG. 5 shows a link between a DL CC (downlink component carrier) and a UL CC (uplink component carrier) in a multiple carrier system according to an exemplary embodiment.

Referring to FIG. 5, in a downlink, Downlink Component Carriers (hereinafter referred to as ‘DL CC’) D1, D2, and D3 are aggregated. In an uplink, Uplink Component Carriers (hereinafter referred to as ‘UL CC’) U1, U2, and U3 are aggregated. Here, Di is the index of a DL CC, and Ui is the index of a UL CC (where i=1, 2, 3). At least one DL CC is a PCC, and the remaining CCs are SCCs. Likewise, at least one UL CC is a PCC, and the remaining CCs are SCCs. For example, D1 and U1 may be PCCs, and D2, U2, D3, and U3 may be SCCs.

In a FDD system, a DL CC and a UL CC are linked to each other in a one-to-one manner. Each of pairs of D1 and U1, D2 and U2, and D3 and U3 is linked to each other in a one-to-one manner. A UE sets up pieces of linkage between the DL CCs and the UL CCs based on system information transmitted on a logical channel BCCH or a UE-dedicated RRC message transmitted on a DCCH. Each of the pieces of linkage may be set up in a cell-specific way or a UE-specific way.

Only the 1:1 linkage between the DL CC and the UL CC is shown in FIG. 5, but a 1:n or n:1 linkage may also be set up. Further, the index of a component carrier does not comply with the sequence of the component carrier or the position of the frequency band of the component carrier.

Hereinafter, power headroom (PH) is described.

Power headroom refers to surplus power that may be additionally used other than power which is now being used by a UE for uplink transmission. For example, it is assumed that a UE has maximum transmission power of 10 W (i.e., uplink transmission power of an allowable range). It is also assumed that the UE is now using power of 9 W in the frequency band of 10 MHz. In this case, power headroom is 1 W because the UE can additionally use power of 1 W.

If a BS allocates a frequency band of 20 MHz to a UE, a power of 9 W×2=18 W is required. If the frequency band of 20 MHz is allocated to the UE, the UE may not use the entire frequency band because the UE has a maximum power of 10 W, or the BS may not properly receive signals from the UE due to the shortage of power. Thus, the UE may report the power headroom of 1 W to the BS so that the BS can perform scheduling within the range of the power headroom. This report is called a Power Headroom Report (PHR).

A periodic PHR method may be used if the power headroom is frequently changed. According to the periodic PHR method, when a periodic timer expires, a UE triggers a PHR. After reporting power headroom, the UE drives the periodic timer again.

Further, if a Path Loss (PL) estimate measured by a UE exceeds a certain reference value, the PHR may be triggered. The PL estimate is measured by a UE on the basis of Reference Symbol Received Power (RSRP).

Although the PL estimate measured by the UE is changed with a specific reference value or higher, the PHR cannot be triggered if a PHR limitation timer driven after a recent PHR does not expire.

Power headroom (P_{PH}) is defined as a difference between a maximum transmission power Pₘₐₓ, configured in a UE, and power P_{estimated} estimated in regard to uplink transmission as in Equation 1 and is represented by decibels (dB).

P_{PH}=Pₘₐₓ−P_{estimated}[dB] [Equation 1]

The power headroom P_{PH} may also be referred to as the remaining power or surplus power. That is, the remainder other than the estimated power P_{estimated} (i.e., the sum of transmitted powers used by CCs in a maximum transmission power of a UE configured by a BS), which becomes the P_{PH} value.

For example, the estimated power P_{estimated} is equal to the power P_{PUSCH} estimated in regard to the transmission of a Physical Uplink Shared Channel. In this case, the power headroom P_{PH} may be calculated according to Equation 2.

P_{pH}=Pₘₐₓ−P_{PUSCH}[dB] [Equation 2]

In another example, the estimated power P_{estimated} is P equal to the sum of power P_{PUSCH} estimated in regard to the transmission of a PUSCH and power P_{PUCCH} estimated in regard to the transmission of a Physical Uplink Control Channel. In this case, the power headroom P_{PH} can be calculated by Equation 3.

P_{PH}=Pₘₐₓ−P_{PUCCH}−P_{PUSCH}[dB] [Equation 3]

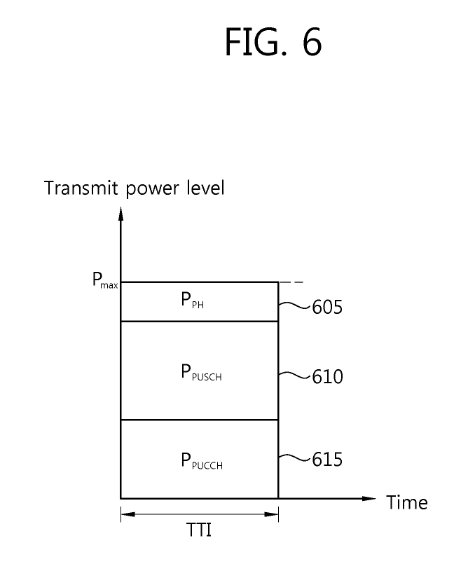

FIG. 6 is a graph showing an example of Power Headroom (PH), which is applied in the time-frequency axis according to an exemplary embodiment.

If the power headroom according to Equation 3 is represented by a graph in the time-frequency axis, it results in FIG. 6. Referring to FIG. 6, the maximum transmission power Pₘₐₓ configured in a UE includes P_{PH} 605, P_{PUSCH} 610, and P_{PUCCH} 615. That is, the remaining power in which the P_{PUSCH} 610 and the P_{PUCCH} 615 have been subtracted from Pₘₐₓ is defined as the P_{PH} 605. Each power is calculated for each Transmission Time Interval (TTI).

If a primary serving cell is a single serving cell which has a UL PCC through which a PUCCH can be transmitted, power headroom is defined as in Equation 2 because a secondary serving cell cannot send a PUCCH, and the operation and the parameters for the PHR method defined by Equation 3 are not defined.

On the other hand, in a primary serving cell, the operation and the parameters for the PHR method defined by Equation 3 may be defined. If a UE has to receive an uplink grant from a BS, send a PUSCH in a primary serving cell, and simultaneously send a PUCCH in the same subframe according to a predetermined rule, the UE calculates both the power headroom according to Equation 2 and the power headroom according to Equation 3 when a PHR is triggered, and transmits the calculated power headroom to a BS.

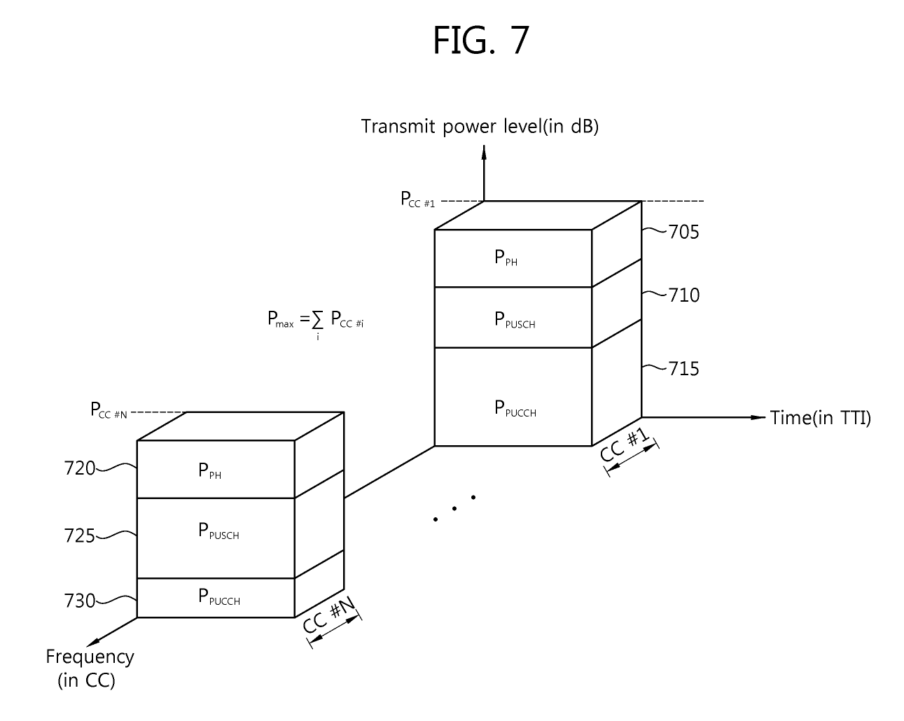

FIG. 7 is a graph showing another example of PH, which is applied in the time-frequency axis according to an exemplary embodiment. In a multi-component carrier system, power headroom for each of a plurality of configured CCs may be defined, which may be represented as a graph in the time-frequency axis as shown in FIG. 7.

Referring to FIG. 7, a maximum transmission power Pₘₐₓ configured for a UE is equal to the sum of transmission powers P_{CC #1}, P_{CC #2} to P_{CC #N} for CC #1, CC #2 to CC #N, respectively. The maximum transmission power for each CC may be generalized as in Equation 4 below.

$${P}_{{CC}_{i}} = {P}_{max} - {\sum }_{j \neq i} {P}_{{CC}_{j}} \qquad [ Equation 4 ]$$

The P_{PH} 705 of the CC #1 is equal to ‘P_{CC #1}−P_{PUSCH} 710−P_{PUCCH} 715, and the P_{PH} 720 of the CC #n is equal to P_{CC #n}−P_{PUSCH} 725−P_{PUCCH} 730. As described above, in a multiple component carrier system, a maximum transmit power of each CC must be taken into consideration to determine a maximum transmit power configured in a UE. Accordingly, the maximum transmit power configured in a UE in a multiple component carrier system is defined differently than a maximum transmit power in a single component carrier system.

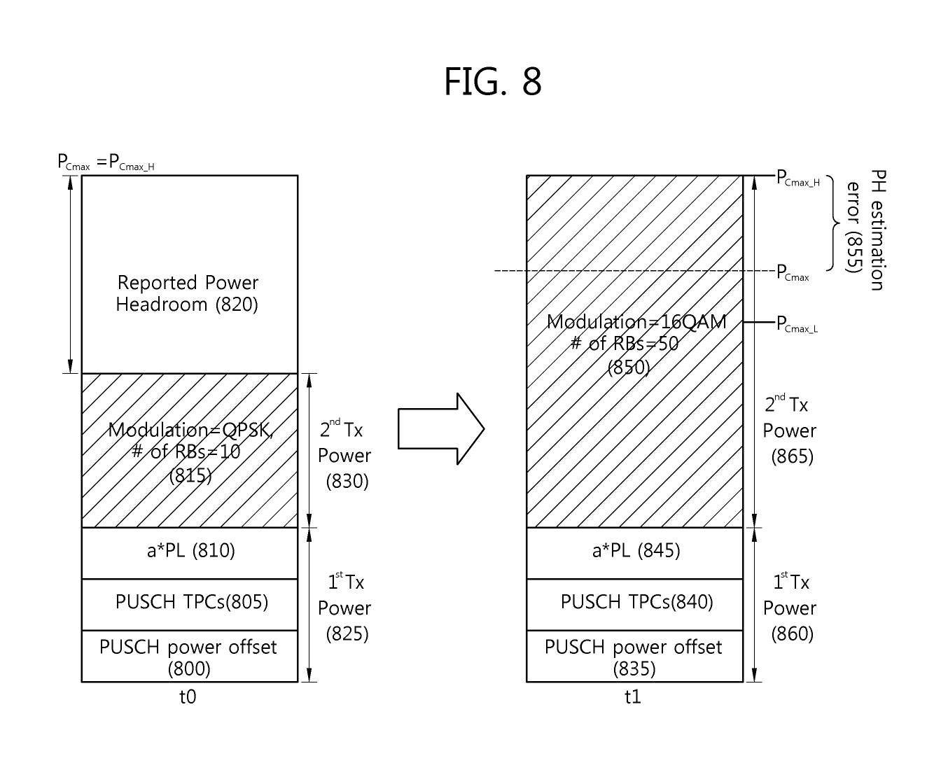

FIG. 8 is a conceptual diagram illustrating the influence of uplink scheduling of a base station on the transmit power of a mobile station in a wireless communication system according to an exemplary embodiment.

Referring to FIG. 8, a UE receives an uplink grant, permitting uplink data transmission, from a BS through a PDCCH at time (or subframe) t0. Accordingly, the UE has to calculate the amount of transmit power in response to the uplink grant at a time t0.

First, at time t0, the UE calculates a first transmit (Tx) power 825 by taking ‘a value’ (received from the BS) (i.e., weight) into account in a PUSCH power offset (800) value received from the BS, a transmit power control (TPC, 805) value, and a path loss (PL) 810 between the BS and the UE. The first transmit power 825 is based on parameters, chiefly influenced by a path environment between the BS and the UE, and parameters determined by the policy of a network. In addition, the UE calculates a second transmit (Tx) power 830 by taking a scheduling parameter 815, indicating a QPSK modulation scheme included in the uplink grant and the allocation of ten resource blocks. The second transmit power 830 is a transmit power changed through the uplink scheduling of the BS.

Accordingly, the UE may calculate a final uplink transmit power by summing the first transmit power 825 and the second transmit power 830. Here, the final uplink transmit power may not exceed a configured maximum UE transmit power PC_{MAX}. In the example of FIG. 8, uplink information complying with the set parameters can be transmitted at the time t0 because the final transmit power is smaller than the value PC_{MAX}. Further, there is a power headroom 820 which is surplus for a transmit power that may be additionally allocated. The power headroom 820 is transmitted from the UE to the BS according to rules defined in a wireless communication system.

At a time t1, the BS changes the scheduling parameter 815 into a scheduling parameter 850, indicating a 16QAM modulation scheme and the allocation of 50 resource blocks, based on the information of the power headroom 820 by taking the transmit power that may be additionally allocated to the UE. The UE reconfigures a second transmit power 865 according to the scheduling parameter 850. The first transmit power 860 at the time t1 is determined by taking ‘a value’ (received from the BS) (i.e., weight) into account in a PUSCH power offset (835) value, a transmit power control (840) value, and a PL 845 between the BS and the UE. Here, it is assumed that the first transmit power 860 at the time t1 is equal to the first transmit power 825 at the time t0.

At time t1, P_{Cmax} is changed to be close P_{Cmax}_{_{—}}_{L}) whereas the sum of the second transmit power 865 and the first transmit power 860 required by the scheduling parameter 850 exceeds P_{Cmax}. That is, there is a PH estimation value error 855 corresponding to ‘P_{Cmax}_{_{—}}_{H}−P_{Cmax}’. If scheduling for uplink resources is performed based on only PH information as described above, performance is degraded because a UE does not configure an uplink transmit power expected by a BS. If a component carrier aggregation method is used, the PH estimation value error 855 becomes larger. Thus, a UE may be able to reduce a configured maximum transmit power, through a process called power coordination (PC).

In either a single component carrier system or a multiple component carrier system, a maximum transmit power configured in a UE is influenced by the power coordination of the UE. The term ‘power coordination’ refers to a maximum uplink transmit power configured in a UE that is reduced within a permitted range, and the power coordination may also be called a Maximum Power Reduction (MPR). Further, the amount of power reduced by the power coordination is called a power coordination amount. The reason why a maximum transmit power configured in a UE is reduced is described below.

When an uplink transmission bandwidth is determined, a relevant signal is controlled so that it is only transmitted in a bandwidth configured by a filter. Here, with an increase in the width of the bandwidth, the number of tab (e.g., registers) forming the filter is increased. In order to satisfy an ideal filter characteristic, the design complexity and size of the filter may increase, while the bandwidth remains the same.

Accordingly, interference power for a band in which uplink transmission is not being performed may be generated according to the characteristic of the filter. If such interference power is to be reduced, a reduction of a maximum transmit power may be achieved via power coordination.

The range of a maximum transmit power in which power coordination is taken into account is as follows.

P_{max-L}≦Pₘₐₓ≦P_{max-H} [Equation 5]

Here, Pₘₐₓ is a maximum transmit power configured in a UE, P_{max-L} is a minimum value of Pₘₐₓ, and P_{max-H} is a maximum value of Pₘₐₓ. More particularly, P_{max-L} and P_{max-H} are calculated according to Equations below.

P_{max-L}=MIN[P_{Emax}−ΔT_{c}, P_{power class}−PC−APC−ΔT_{c]} [Equation 6]

P_{max-H}=MIN[P_{Emax}, P_{power class}] [Equation 7]

Here, MIN[a,b] is the smaller of values a and b, and P_{Emax} is a maximum power determined by the RRC signaling of a BS. ΔT_{C} is the amount of power which is used when there is uplink transmission at the edge of a frequency band, and it has 1.5 dB or 0 dB according to the bandwidth. P_{powerclass} is a power value according to several power classes defined in order to support various specifications of a UE in a system. In general, an LTE system supports a power class 3. P_{powerclass} according to the power class 3 is 23 dBm. PC is a power coordination amount, and APC (Additional Power Coordination) is an additional power coordination amount signaled by a BS.

The power coordination may be set to a specific range or may be set to a specific constant. The power coordination may be defined for every UE or may be defined for every CC. The power coordination may be set to a range or a constant within each CC. Further, the power coordination may be set to a range or a constant according to whether the PUSCH resource allocation of each CC is contiguous or non-contiguous. Further, the power coordination may be set to a range or a constant according to whether a PUCCH exists or not.

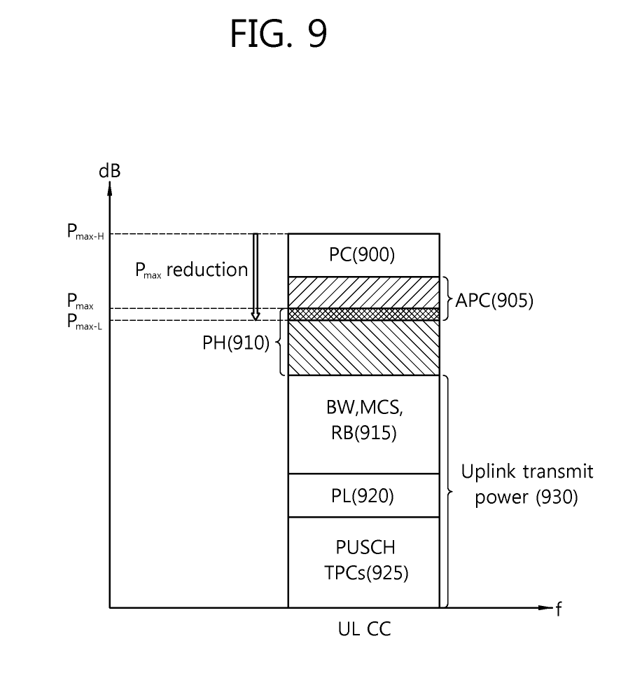

FIG. 9 is an explanatory diagram illustrating the power coordination amount and the maximum transmit power in a multiple component carrier system according to an exemplary embodiment. It is assumed that only one UL CC is allocated to a UE, for convenience.

Referring to FIG. 9, assuming that ΔT_{C}=0, the maximum value P_{max-H} of the maximum transmit power Pₘₐₓ may be 23 dBm corresponding to the power class 3. The minimum value P_{max-L} of the maximum transmit power Pₘₐₓ is a value in which a power coordination amount (PC) 900 and an additional power coordination amount (APC) 905 have been subtracted from the maximum value P_{max-H}. That is, a UE reduces the minimum value Pₘₐₓ L of the maximum transmit power Pₘₐₓ using the power coordination amount (PC) 900 and the additional power coordination amount (APC) 905. The maximum transmit power Pₘₐₓ is determined between the maximum value P_{max-H} and the minimum value P_{max-L}.

The uplink transmit power 930 is the sum of power 915 determined by a bandwidth BW, an MCS, and an RB, a PL 920, and PUSCH transmit power controls (TPC) 925. The PH 910 is a value in which the uplink transmit power 930 has been subtracted from the maximum transmit power Pₘₐₓ.

Only one UL CC has been described with reference to FIG. 9. If a plurality of UL CCs is allocated, the maximum transmit power may be determined for every UE and not for every UL CC. The maximum transmit power for each UE may be calculated as the sum of maximum transmit powers for all UL CCs.

In calculating the maximum transmit power, the P_{Emax}, the ΔT_{C}, the P_{powerclass}, and the additional power coordination amount (APC) correspond to pieces of information that are known to or that may be known to a BS. Since the BS is unable to know the power coordination amount (PC), the BS cannot know the maximum transmit power according to the power coordination amount (PC). However, when a UE reports power headroom to a BS, the BS may approximately estimate the maximum transmit power based on the power headroom. The BS performs uncertain uplink scheduling based on the estimated maximum transmit power. Accordingly, in a worst case scenario, the BS may perform scheduling with a modulation scheme, a channel bandwidth, and the number of RBs which require transmit power higher than a maximum transmit power for the UE. This problem becomes more severe in a multiple component carrier system.

Further, the maximum transmit power may have to be limited according to the type of a signal that is currently being transmitted based on a hardware construction that is based on characteristic information unique to a UE. The hardware construction within the UE includes an RF (Radio Frequency) processing unit, also referred to as an RF chain. For the unity of terms, the hardware construction within the UE is called the RF chain for purpose of this disclosure. The RF chain includes a combination of a power amplifier, a filter, and an antenna within the hardware construction of the UE. Furthermore, the RF chain may be defined by each of the power amplifier, the filter, and the antenna. One RF chain may be included in one UE, or a plurality of RF chains may be included in one UE. For example, if one UE includes one antenna and the antenna is connected to a first power amplifier connected to a first filter and to a second power amplifier connected to a second filter, the one UE constructs two RF chains.

If several CCs exist, or one or more RF chains exist, or both, a communication environment formed by a combination of the CCs and the RF chains may be different, and the number of cases of uplink scheduling may be numerous. Thus a variance of the power coordination may also be large, and difficult to estimate. Accordingly, a new design of a range of the power coordination may be set by taking not only uplink scheduling parameters (a modulation scheme, a channel bandwidth, the number of RBs, etc.), but also the hardware characteristic of a UE, such as the RF chain, and multiple CCs into consideration.

There are several techniques for a BS to obtain information about the power coordination of a UE. For example, there is a technique of a BS to directly receive information about power coordination, supported by a UE for all communication environments, from the UE. In another example, there is a technique of a BS to receive only indices, specified by the BS, from a UE in the state in which information about the power coordination of the UE in all cases has been indexed and known between the UE and the BS. In another example, there is a technique of a BS to receive characteristic information unique to a UE that determines a range of the power coordination from the UE and is indirectly aware of information about the power coordination.

A BS may be aware of information about the power coordination if it uses any of the above mentioned techniques. However, there is a difference in a technique of obtaining the information about power coordination. The construction of information transmitted by a UE may differ according to each of the techniques. Accordingly, the BS first specifies a technique of obtaining a range of the power coordination, and the UE may be able to provide information based on a construction according to the specified technique.

The BS may request subsidiary information (SI) from the UE in order to obtain the information about power coordination. A message used at this time is called a subsidiary information request message. The subsidiary information is information additionally used for the BS to be aware of the information about power coordination, or to indirectly induce the information about power coordination. That is, the subsidiary information is control information to induce the information about power coordination. The subsidiary information may be referred to as control information about power coordination. The subsidiary information may be additionally included in the existing message used in a UE information procedure, which will be described later in more detail.

Further, in order to request and obtain the subsidiary information including information about the hardware capability of a UE, a BS performs a UE capability transfer procedure with the UE. Here, the subsidiary information may be called UE capability information.

In response to the subsidiary information request message, the UE may provide the BS with the subsidiary information. A message containing the subsidiary information is called a subsidiary information response message.

The subsidiary information, the subsidiary information request message, and the subsidiary information response message are described in more detail below.

1. Subsidiary Information

(1) For example, the subsidiary information may include characteristic information about the hardware construction of a UE. The hardware construction includes an RF chain. Further, the characteristic information may be information that provides the number of RF chains supportable by the UE, a frequency band characteristic, and the like.

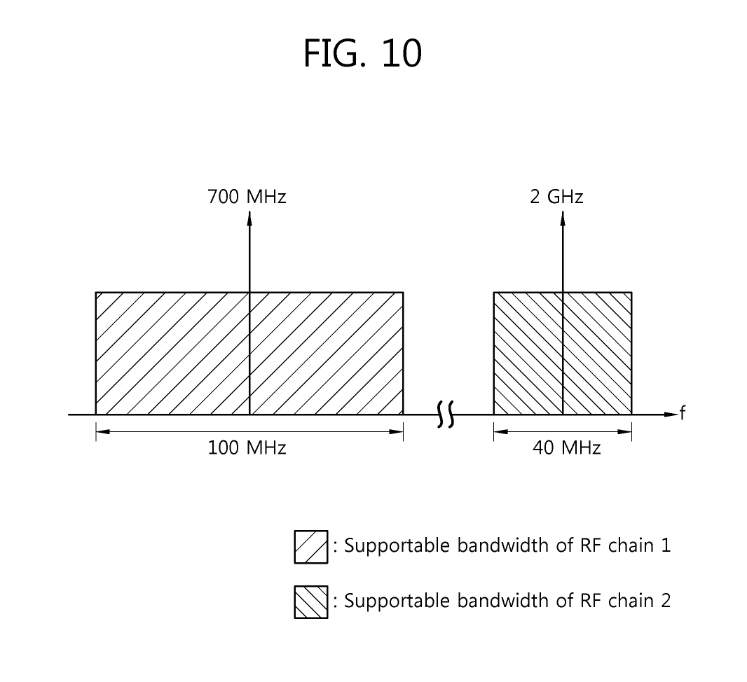

FIG. 10 is an explanatory diagram illustrating subsidiary information according to an exemplary embodiment. Specifically, FIG. 10 shows an example in which the subsidiary information is characteristic information about the RF chain itself of a UE.

Referring to FIG. 10, the number of RF chains configured in a UE is two (RF chain 1 and RF chain 2). Characteristic information about the RF chain itself includes information about a frequency band and bandwidth supportable by the UE.

The supportable frequency band of the RF chain 1 on the frequency band is 700 MHz, and the supportable bandwidth of the RF chain 1 on the frequency band is 100 MHz. The supportable frequency band of the RF chain 2 on the frequency band is 2 GHz, and the supportable bandwidth of the RF chain 2 on the frequency band is 40 MHz. Characteristic information may differ for every RF chain. The difference between pieces of the characteristic information may result in a difference between the ranges of power coordination. If a BS and a UE are aware of a range of power coordination according to characteristic information about an RF chain in all cases, they can be aware of the range of power coordination by exchanging only the characteristic information of the RF chain.

Table 1 shows subsidiary information according to an exemplary embodiment.

TABLE 1

| TABLE | | |
|---|---|---|
| INDEX | CHARACTERISTIC INFORMATION | |
| 1 | Number of RF chains | 2 |
| | Supportable band | RF chain 1 = 700 MHz, RF chain 2 = |
| | | 2 GHz |
| | Supportable bandwidth | RF chain 1 = 10 MHz, RF chain 2 = |
| | | 10 MHz |
| 2 | Number of RF chains | 2 |
| | Supportable band | RF chain 1 = 2 GHz, RF chain 2 = |
| | | 3 GHz |
| | Supportable bandwidth | RF chain 1 = 20 MHz, RF chain 2 = |
| | | 20 MHz |

.
.
.

| | | |
|---|---|---|
| N | Number of RF chains | 3 |
| | Supportable band | RF chain 1 = 700 MHz, RF chain 2 = |
| | | 2 GHz, RF chain 3 = 3 GHz |
| | Supportable bandwidth | RF chain 1 = 10 MHz, RF chain 2 = |
| | | 50 MHz, RF chain 3 = 50 MHz |

Referring to Table 1, subsidiary information has a table format, and it is a set of pieces of the characteristic information. The index of each table indicates the characteristic information of a specific state. For example, in the characteristic information of table index 1, the number of RF chains of a UE is 2, the supportable frequency bands of the RF chains 1 and 2 are 700 MHz and 2 GHz, and the supportable bandwidths of the RF chains 1 and 2 are 10 MHz and 10 MHz. The subsidiary information is information about the RF chain itself of the UE. The subsidiary information, indicating the supportable frequency band and bandwidth of each RF chain, includes information identifying an uplink operating frequency band and a downlink operating frequency band used to communicate between a UE and a BS.

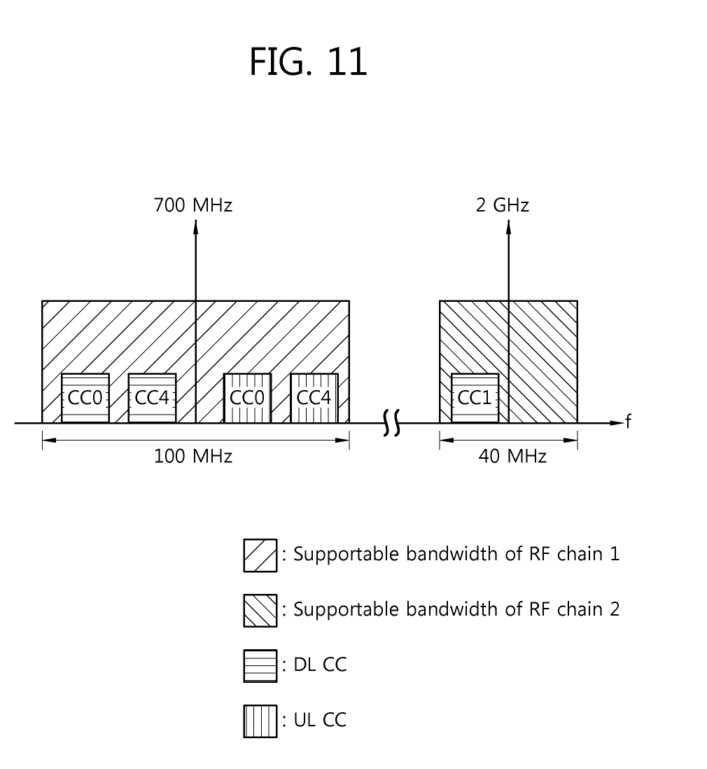

FIG. 11 is an explanatory diagram illustrating subsidiary information according to an exemplary embodiment. FIG. 11 shows an example in which the subsidiary information is characteristic information about a CC supported in a hardware construction. Here, the CC is a CC now configured in a UE.

Referring to FIG. 11, the number of RF chains configured in a UE are 2 (i.e., an RF chain 1 or an RF chain 2). The supportable frequency band and the supportable bandwidth of the RF chain 1 are 700 MHz and 100 MHz, respectively. And the supportable frequency band and the supportable bandwidth of the RF chain 2 are 2 GHz and 40 MHz, respectively.

If at least one CC is configured in a UE, each CC must be supported in at least one RF chain according to characteristic information. Each RF chain supports the CC of a specific index. In relation to DL CC0, DL CC4, UL CC0, UL CC4, and DL CC1 configured in a UE, the RF chain 1 supports the DL CC0, the DL CC4, the UL CC0, and the UL CC4, and the RF chain 2 supports only the DL CC1. Information about a CC supported in each hardware construction may be defined as characteristic information. That is, the characteristic information includes information about the number of CCs, supported by each RF chain, and the index of each CC.

Table 2 shows subsidiary information according to another exemplary embodiment of the present invention.

TABLE 2

| TABLE | | |
|---|---|---|
| INDEX | CHARACTERISTIC INFORMATION | |
| 1 | Number of RF chains | 2 |
| | Supportable band | RF chain 1 = 700 MHz, RF chain 2 = 2 GHz |
| | Supportable bandwidth | RF chain 1 = 10 MHz, RF chain 2 = 10 MHz |
| | Maximum number of | RF chain 1 = 4, RF chain 2 = 1 |
| | supportable CCs | |
| | Supportable CC index | RF chain 1 = {CC0, CC1, CC2, CC3}, |
| | | RF chain 2 = {CC4} |
| 2 | Number of RF chains | 2 |
| | Supportable band | RF chain 1 = 2 GHz, RF chain 2 = 3 GHz |
| | Supportable bandwidth | RF chain 1 = 20 MHz, RF chain 2 = 20 MHz |
| | Maximum number of | RF chain 1 = 2, RF chain 2 = 2 |
| | supportable CCs | |
| | Supportable CC index | RF chain 1 = {CC0, CC1}, |
| | | RF chain 2 = {CC2, CC3} |

.
.
.

| | | |
|---|---|---|
| N | Number of RF chains | 3 |
| | Supportable band | RF chain 1 = 700 MHz, RF chain 2 = 2 GHz, |
| | | RF chain 3 = 3 GHz |
| | Supportable bandwidth | RF chain l = 10 MHz, RF chain 2 = 50 MHz, |
| | | RF chain 3 = 50 MHz |
| | Maximum number of | RF chain 1 = 2, RF chain 2 = 2, RF chain 3 = 3 |
| | supportable CCs | |
| | Supportable CC index | RF chain l = {CC0, CC1}, RF chain 2 = {CC2, CC3, |
| | | CC4}, RF chain 3 = {CC5, CC6, CC7} |

Referring to Table 2, subsidiary information has a set of pieces of characteristic information. The index of each table indicates the characteristic information of a specific state. For example, in the characteristic information of the table index 1, the number of RF chains of a UE is 2, the supportable frequency bands of the RF chains 1 and 2 are 700 MHz and 2 GHz respectively, and the supportable bandwidths of the RF chains 1 and 2 are 10 MHz and 10 MHz respectively. As described above, the subsidiary information, indicating the supportable frequency band and bandwidth of each RF chain, includes information identifying an uplink operating frequency band and a downlink operating frequency band used to communicate between a UE and a BS.

Here, if a plurality of RF chains are configured in a UE, the supportable frequency bands and the supportable bandwidths of the RF chains become a combination of the frequency bands supportable by the UE. For example, in case of the table index N, the supportable frequency bands of the RF chains 1, 2, and 3 are 700 MHz, 2 GHz, and 3 GHz, respectively, which are maximum combination information (maxBandComb) indicating all the supportable frequency bands of a UE. That is, the maximum combination information is induced based on the number of RF chains of the UE. The maximum combination information may include information about combinations supportable by a UE at the same time. The maximum combination information may further include information about the number of combinations supportable by the UE simultaneously.

The table index 1 shows an example in which the maximum number of CCs supportable by the RF chain 1 is 4, the maximum number of CCs supportable by the RF chain 2 is 1, the RF chain 1 supports (CC0, CC1, CC2, CC3), and the RF chain 2 supports {CC4}. The supportable frequency band and the supportable bandwidth of each RF chain may be formed by an aggregation of CCs supportable by the RF chain. A bandwidth class may be defined by both the maximum number of CCs and the bandwidth supportable by a UE, as described above. The bandwidth class may be indicated by a table index as in Table 2, which indicates the maximum number of CCs and a bandwidth supportable by a UE.

Comparing Table 2 with Table 1, the characteristic information according to Table 2 further includes information about the maximum number of CCs supportable by each chain and index information about each of CCs supported in each RF chain, as well as the characteristic information of the RF chain itself, such as the frequency band and the bandwidth.

Table 3 shows an example of subsidiary information.

TABLE 3

| TABLE | | |
|---|---|---|
| INDEX | CHARACTERISTIC INFORMATION | |
| 1 | Number of RF chains | 2 |
| | Supportable CC | RF chain l = {CC0, CC4}, RF chain 2 = |
| | indices | {CC1} |
| 2 | Number of RF chains | 2 |
| | Supportable CC | RF chain l = {CC0, CC1}, RF chain 2 = |
| | indices | {CC2, CC3} |
| . | | |
| . | | |
| . | | |
| N | Number of RF chains | 3 |
| | Supportable CC | RF chain l = {CC0, CC1}, RF chain 2 = |
| | indices | {CC2, CC3, CC4}, RF chain 3 = |
| | | {CC5, CC6, CC7} |

Unlike the characteristic information of Table 2, the characteristic information of Table 3 includes only the number of RF chains, configured in a UE, and pieces, of index information about CCs now being supported in each RF chain. That is, the characteristic information of Table 3 does not include characteristic information about the RF chain itself, such as a supportable band and a supportable bandwidth.

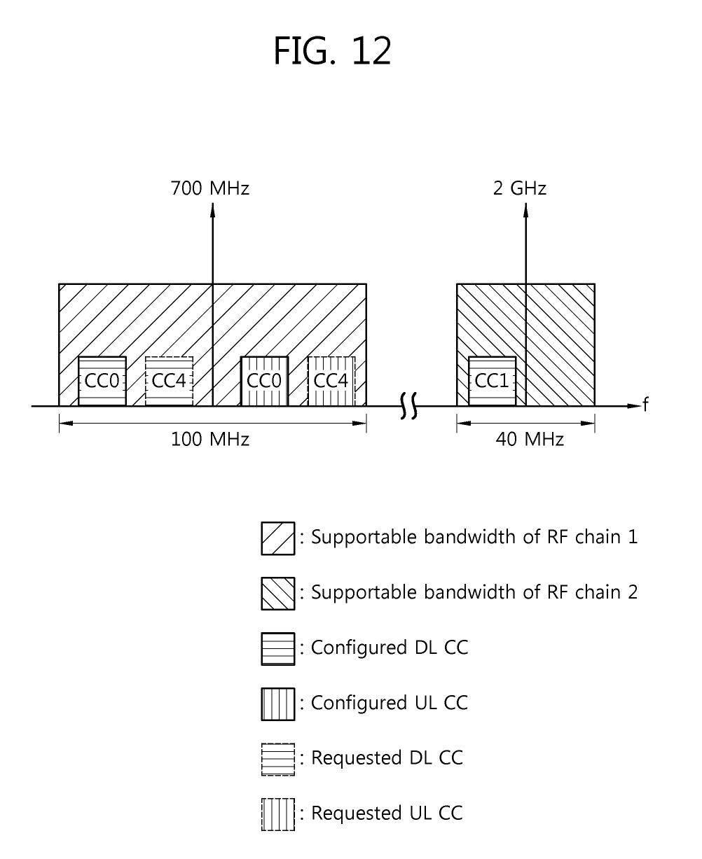

FIG. 12 is an explanatory diagram illustrating subsidiary information according to an exemplary embodiment. Specifically, FIG. 12 shows an example in which the subsidiary information is characteristic information about a supportable RF chain according to the indices of a DL CC and a UL CC that the RF chain supports now configured CCs and the characteristic values of the CCs.

Referring to FIG. 12, the number of RF chains configured in a UE are 2 (RF chain 1 or RF chain 2). The supportable band and the supportable bandwidth of the RF chain 1 are 700 MHz and 100 MHz, respectively. The supportable band and the supportable bandwidth of the RF chain 2 are 2 GHz and 40 MHz, respectively.

If CCs requested by a BS are DL CC4 and UL CC4 in the state in which the existing CCs configured in a UE are DL CC0, UL CC0, and DL CC1, the UE provides characteristic information about an RF chain that can support the requested CCs.

The indices of the requested CCs shown in FIG. 12 are inserted, for the sake of convenience. A UE may determine the supportable RF chain by taking only CC characteristic values (the center frequency, the bandwidth, etc.) into account. Furthermore, if the RF chain of a relevant UE is not supported, the UE may inform a BS that the RF chain is not supported.

Characteristic information about an RF chain itself may further include information about a supportable band and a supportable bandwidth.

In another example, subsidiary information is information about power coordination. For example, the information about power coordination is information having a format that directly indicates the amount or range of power coordination for a UE to which a scheduling parameter of a specific state has been allocated.

The scheduling parameter is information, including at least one of a modulation scheme, a channel bandwidth, and the number of RBs. The scheduling parameter of a specific state refers to a scheduling parameter if a specific value is applied to each scheduling parameter. For example, Table 4 below shows an example of the scheduling parameter of a specific state.

TABLE 4

| | | Channel bandwidth/Transmission | | | | | |
|---|---|---|---|---|---|---|---|
| | | bandwidth configuration (RB) | | | | | |
| Scheduling | | 1.4 | 3.0 | 5 | 10 | 15 | 20 |
| Parameter | Modulation | MHz | MHz | MHz | MHz | MHz | MHz |
| Sequence 0 | QPSK | >5 | >4 | >8 | >12 | >16 | >18 |
| Sequence 1 | 16 QAM | ≦5 | ≦4 | ≦8 | ≦12 | ≦16 | ≦18 |
| Sequence 2 | 16 QAM | >5 | >4 | >8 | >12 | >16 | >18 |

Referring to Table 4, the scheduling parameters of a specific state are any one of the sequence 0, the sequence 1, and the sequence 2. In case of the sequence 0, the specific value applied to each scheduling parameter is described below. Sequence 0 includes the channel bandwidth of 1.4 MHz and the number of RBs greater than 5 in the state in which the modulation scheme is QPSK. Further, in the state in which the modulation scheme is QPSK, the channel bandwidth pf 3.0 MHz and 5 or more resource blocks also correspond to sequence 0. In this manner, the 6 scheduling parameters of a specific state correspond to sequence 0.

Further, in the state in which the modulation scheme is 16 QAM (Quadrature Amplitude Modulation), the scheduling parameters of a specific state based on a specific channel bandwidth and the number of specific resource blocks correspond to sequence 1 or sequence 2.

All the scheduling parameters of a specific state belonging to the same sequence may be mapped to the same amount or range of power coordination, and the scheduling parameters of a specific state belonging to different sequences may be mapped to different amounts or ranges of power coordination. That is, the sequence indicates a set of scheduling parameters of a specific state which are mapped to the same amount or range of power coordination, and an example thereof is shown in Table 5.

TABLE 5

| Sched- | | Channel bandwidth/Transmission bandwidth configuration (RB) | | | | | | |
|---|---|---|---|---|---|---|---|---|
| uling | Modu- | 1.4 | 3.0 | 5 | 10 | 15 | 20 | PC |
| Parameter | lation | MHz | MHz | MHz | MHz | MHz | MHz | (dB) |
| Sequence 0 | QPSK | >5 | >4 | >8 | >12 | >16 | >18 | ≦1 |
| Sequence 1 | 16 | ≦5 | ≦4 | ≦8 | ≦12 | ≦16 | ≦18 | ≦2 |
| | QAM | | | | | | | |
| Sequence 2 | 16 | >5 | >4 | >8 | >12 | >16 | >18 | ≦3 |
| | QAM | | | | | | | |

Referring to Table 5, the scheduling parameters of a specific state corresponding the sequence 0 are mapped to the power coordination amount (PC) within a range of 1 dB or less, the scheduling parameters of a specific state corresponding to the sequence 1 are mapped to the power coordination amount within a range of 2 dB or less, and the scheduling parameters of a specific state corresponding to the sequence 2 are mapped to the power coordination amount within a range of 3 dB or less.

Pieces of information about the power coordination may be represented in various forms, such as a table, an index, and a set of several information elements.

For example, the pieces of information about the power coordination may be constructed in the form of a table, indicating a mapping relationship between parameters regarding uplink scheduling for a UE, all conditions formed by the number of CCs configured in the UE and the number of RFs supported by the UE, and the amount or range of power coordination for all the conditions.

Table 6 below shows an example in which pieces of information about the power coordination is constructed in the form of a table. This table shows an example in which the total number of CCs aggregatable by a UE is 5, a power class is 3, and the number of supportable RFs is 2.

TABLE 6

| | | Channel bandwidth/Transmission bandwidth configuration (RB) | | | | | | PC |
|---|---|---|---|---|---|---|---|---|
| | Modulation | 1.4 MHz | 2.5 MHz | 5 MHz | 10 MHz | 15 MHz | 20 MHz | (dB) |
| #CCs = 1, | QPSK | >5 | >4 | >8 | >12 | >16 | >18 | ≦1 |
| #RF = 1 | 16QAM | ≦5 | ≦4 | ≦8 | ≦12 | ≦16 | ≦18 | ≦1 |
| | 16QAM | >5 | >4 | >8 | >12 | >16 | >18 | ≦2 |
| #CCs = 2, | QPSK, QPSK | >5, >5 | >4, >4 | >8, >8 | >12, >12 | >16, >16 | >18, >18 | 3 ≦ x ≦ 4 |
| #RF = 1 | QPSK, 16QAM | >5, ≦5 | >4, ≦4 | >8, ≦8 | >12, ≦12 | >16, ≦16 | >18, ≦18 | 3 ≦ x ≦ 4 |
| | QPSK, 16QAM | >5, >5 | >4, >4 | >8, >8 | >12, >12 | >16, >16 | >18, >18 | 5 ≦ x ≦ 6 |
| | 16QAM × 2 | ≦5, ≦5 | ≦4, ≦4 | ≦8, ≦8 | ≦12, ≦12 | ≦16, ≦16 | ≦18, ≦18 | 3 ≦ x ≦ 4 |
| | 16QAM × 2 | >5, ≦5 | >4, ≦4 | >8, ≦8 | >12, ≦12 | >16, ≦16 | >18, ≦18 | 5 ≦ x ≦ 6 |
| | 16QAM × 2 | >5, >5 | >4, >4 | >8, >8 | >12, >12 | >16, >16 | >18, >18 | 8 ≦ x ≦ 10 |
| #CCs = 2, | QPSK, QPSK | >5, >5 | >4, >4 | >8, >8 | >12, >12 | >16, >16 | >18, >18 | ≦2 |
| #RF = 2 | QPSK, 16QAM | >5, ≦5 | >4, ≦4 | >8, ≦8 | >12, ≦12 | >16, ≦16 | >18, ≦18 | 3 ≦ x ≦ 5 |
| | QPSK, 16QAM | >5, >5 | >4, >4 | >8, >8 | >12, >12 | >16, >16 | >18, >18 | 5 ≦ x ≦ 7 |
| | 16QAM × 2 | ≦5, ≦5 | ≦4, ≦4 | ≦8, ≦8 | ≦12, ≦12 | ≦16, ≦16 | ≦18, ≦18 | 5 ≦ x ≦ 7 |
| | 16QAM × 2 | >5, ≦5 | >4, ≦4 | >8, ≦8 | >12, ≦12 | >16, ≦16 | >18, ≦18 | 7 ≦ x ≦ 9 |
| | 16QAM × 2 | >5, >5 | >4, >4 | >8, >8 | >12, >12 | >16, >16 | >18, >18 | 9 ≦ x ≦ 11 |

. . .
. . .
. . .
. . .

| | | | | | | | | |
|---|---|---|---|---|---|---|---|---|
| #CCs = 5, | QPSK, QPSK, | >5, >5, >5, | >4, >4, >4, | >8, >8, >8, | >12, >12, >12, | >16, >16, >16, | >18, >18, >18, | ≦2 |
| #RF = 2 | QPSK, QPSK, | >5, >5 | >4, >4 | >8, >8 | >12, >12 | >16, >16 | >18, >18 | |
| | QPSK | | | | | | | |
| | QPSK, QPSK, | >5, >5, >5, | >4, >4, >4, | >8, >8, >8, | >12, >12, >12, | >16, >16, >16, | >18, >18, >18, | 2 ≦ x ≦ 4 |
| | QPSK, QPSK, | >5, ≦5 | >4, ≦4 | >8, ≦8 | >12, ≦12 | >16, ≦16 | >18, ≦18 | |
| | 16QAM | | | | | | | |
| | . | . | . | . | . | . | . | . |
| | . | . | . | . | . | . | . | . |
| | . | . | . | . | . | . | . | . |
| | 16QAM × 5 | >5, >5, >5, | >4, >4, >4, | >8, >8, >8, | >12, >12, >12, | >16, >16, >16, | >18, >18, >18, | 10 ≦ x ≦ 12 |
| | | >5, >5 | >4, >4 | >8, >8 | >12, >12 | >16, >16 | >18, >18 | |

Referring to Table 6, #CCs are the number of CCs actually configured in a UE, from among a total of aggregated CCs, and #RF is the number of actually used RFs, from among supportable RFs. Table 2 defines the amount or range of the power coordination (PC) in communication environments under several conditions which are specified by the number of CCs, the number of RFs, the modulation scheme, the channel bandwidth, and the number of RBs regarding a UE.

It is assumed that a communication environment includes #CCs=5 and #RF=2 configured in a UE. If 5 CCs have been modulated according to QPSK, QPSK, QPSK, QPSK, and 16QAM, respectively, and 20 RBs have been scheduled for each of the 5 CCs for the UE in a 20 MHz system, a range of power coordination for the UE is 2 dB to 4 dB. Accordingly, the UE may reduce the configured maximum transmit power by up to 2 dB to 4 dB.

Table 6 is an example in which the total number of CCs aggregated by a UE is 5, the power class is 3, and the number of supportable RFs is 2. These are factors to determine the unique specification of the UE. These may be fixed and stored in the UE.

Accordingly, a new table may be defined by a new combination of the number of aggregated CCs, the number of supportable RFs, and a power class. However, a UE sends the table itself to a BS as information about power coordination, because the BS does not contain the new table. A table (i.e., the information about power coordination) is hereinafter called a power coordination table.

In the power coordination table, if each scheduling parameter is indicated by a sequence information about power coordination, this may indicate that the range or amount of power coordination is different. This is represented according to a sequence shown in Table 7.

TABLE 7

| UE-PC infomation | SEQUENCE (SIZE (1 . . . maxSQ_index)){ |
|---|---|
| SQ_index | Interger {0 . . . 31} |
| PCValue_Low | Interger {0 . . . 10} |
| PCValue_High | Interger {0 . . . 10} |
| PC_Offset | Interger {0 . . . 10} |
| } | |

Referring to Table 7, the UE-PC information refers to information about power coordination specific to a UE. The sequence index SQ_index is an index used to identify a sequence. The sequence index is an integer ranging from 0 to 31. 31 corresponds to a maximum sequence index maxSQ_index. The size of the sequence is varied from 1 to a maximum sequence index. The power coordination minimum value PCValue_Low is a minimum value of power coordination applied to a UE, and the power coordination maximum value PCValue_High is a maximum value of power coordination applied to a UE. The power coordination offset PC_offset is the amount or range of power coordination (dB) configured, irrespective of the scheduling of a UE.

For example, if three UL CCs {CC1, CC3, CC4} are configured in a UE, it is assumed that resources are allocated to two UL CCs {CC1, CC3} of the three UL CCs and data is transmitted through the two UL CCs. If the CC1 is set as a PSC (Primary Serving Cell, a PUCCH is allocated, and the amount or range of power coordination calculated by the UE is configured, the power coordination minimum value and the power coordination maximum value are determined according to resources allocated to the CC1 and the CC3. Further, the power coordination offset value is additionally set according to whether PUCCH has been allocated.

Here, if a value of power coordination is not defined as a range value, a single power coordination value PCValue may be included instead of the power coordination minimum value PCValue_Low and the power coordination maximum value PCValue_High.

In another example, information about power coordination includes some UL CC combinations configurable by a UE and values of power coordination which are calculated when a PUCCH is configured in each UL CC. In this case, the information about power coordination is set on the basis of a power coordination table, and a sequence is defined on the basis of an additional table configured using only values of power coordination for the current configuration of UL CCs in the above information. Table 8 shows an example in which only one UL CC exists.

TABLE 8

| Scheduling | | Channel bandwidth/Transmission bandwidth configuration (RB) | | | | | | PC |
|---|---|---|---|---|---|---|---|---|
| Parameter | Modulation | 1.4 MHz | 2.5 MHz | 5 MHz | 10 MHz | 15 MHz | 20 MHz | (dB) |
| Sequence 0 | QPSK, QPSK | >5, >5 | >4, >4 | >8, >8 | >12, >12 | >16, >16 | >18, >18 | 1 ≦ x ≦ 2 |
| Sequence 1 | QPSK, 16QAM | >5, <5 | >4, <4 | >8, <8 | >12, <12 | >16, <16 | >18, <18 | 1 ≦ x ≦ 2 |
| Sequence 2 | QPSK, 16QAM | >5, >5 | >4, >4 | >8, >8 | >12, >12 | >16, >16 | >18, >18 | 2 ≦ x ≦ 3 |
| Sequence 3 | 16QAM × 2 | <5, <5 | <4, <4 | <8, <8 | <12, <12 | <16, <16 | <18, <18 | 1 ≦ x ≦ 2 |
| Sequence 4 | 16QAM × 2 | >5, <5 | >4, <4 | >8, <8 | >12, <12 | >16, <16 | >18, <18 | 2 ≦ x ≦ 3 |
| Sequence 5 | 16QAM × 2 | >5, >5 | >4, >4 | >8, >8 | >12, >12 | >16, >16 | >18, >18 | 3 ≦ x ≦ 5 |

2. Subsidiary Information Request Message

The subsidiary information request message is a message in which a BS requests subsidiary information from a UE. The subsidiary information request message may be generated in the physical layer, the MAC layer, or the RRC layer. Table 9 shows an example in which a requested subsidiary information includes only characteristic information about a hardware construction.

TABLE 9

| | | |
|---|---|---|
| SubsidiaryInformationRequest | ::= | SEQUENCE { |

| | |
|---|---|
| SubsidiaryInformationRequest | SubsidiaryInformationRequest-IEs, |

}

| | |
|---|---|
| SubsidiaryInformationRequest-IEs ::= | SEQUENCE { |

| CI-ReportReq | BOOLEAN, | |
|---|---|---|
| nonCriticalExtension | SEQUENCE { } | OPTIONAL-- Need OP |

}

Referring to Table 9, subsidiary information request information element (IE) includes a characteristic information (CI) request (CI-ReportReq) field. The characteristic information request field is used to indicate whether characteristic information about the hardware construction of a UE is requested.

Table 10 shows an example in which requested subsidiary information includes only information about power coordination.

TABLE 10

| | | |
|---|---|---|
| SubsidiaryInformationRequest | ::= | SEQUENCE { |

| | |
|---|---|
| SubsidiaryInformationRequest | SubsidiaryInformationRequest-IEs, |

}

| | |
|---|---|
| SubsidiaryInformationRequest-IEs ::= | SEQUENCE { |

| PC-ReportReq | BOOLEAN, | |
|---|---|---|
| nonCriticalExtension | SEQUENCE { } | OPTIONAL-- Need OP |

}

Referring to Table 10, a subsidiary information request information element includes a power coordination request (PC-ReportReq) field. The power coordination request field is used to indicate whether a UE requests information about power coordination.

Table 11 shows an example in which requested subsidiary information includes characteristic information about a hardware construction and information about power coordination.

TABLE 11

| | | |
|---|---|---|
| SubsidiaryInformationRequest | ::= | SEQUENCE { |

| | |
|---|---|
| SubsidiaryInformationRequest | SubsidiaryInformationRequest-IEs, |

}

| | |
|---|---|
| SubsidiaryInformationRequest-IEs ::= | SEQUENCE { |

| CI-ReportReq | BOOLEAN, | |
|---|---|---|
| PC-ReportReq | BOOLEAN, | |
| nonCritical Extension | SEQUENCE { } | OPTIONAL-- Need OP |

}

Referring to Table 11, a subsidiary information request information element includes a characteristic information request (CI-ReportReq) field and a power coordination request (PC-ReportReq) field.

3. Subsidiary Information Response Message

The subsidiary information response message is information transmitted from a UE to a BS in response to a subsidiary information request message. The subsidiary information response message includes subsidiary information requested by a BS. Alternatively, the subsidiary information response message may be information that simply transmits subsidiary information. In this case, the subsidiary information may be transmitted to a BS through the subsidiary information response message even without a request of the BS. The subsidiary information response message may be generated in the physical layer, the MAC layer, or the RRC layer. Table 12 shows an example in which subsidiary information to respond to includes only characteristic information about a hardware construction.

TABLE 12

| | | |
|---|---|---|
| SubsidiaryInformationResponse | ::= | SEQUENCE { |

| | |
|---|---|
| SubsidiaryInformationResponse | SubsidiaryInformationResponse-IEs, |

}
SubsidiaryInformationResponse-IEs ::= SEQUENCE {

| | |
|---|---|
| No of RF chain | INTEGER (1..maxRF), |
| CI-Report | SEQUENCE (SIZE (1..maxRF)) OF SEQUENCE { |

```
  Center Freqeuncy,
  Bandwidth
```

| | |
|---|---|
| } | OPTIONAL, |

}

Referring to Table 12, a subsidiary information response information element (IE) includes a field about the number of RF chains (No of RF chain) and a characteristic information response (CI-Report) field. The subsidiary information response information element is transmitted when a UE receives subsidiary information request information including a characteristic information request field. The characteristic information response field includes characteristic information about the hardware construction of a UE (e.g., information about the frequency band, center frequency) and the bandwidth of a RF chain.

Table 13 shows an example in which subsidiary information for the response includes only information about power coordination.

TABLE 13

| | | |
|---|---|---|
| SubsidiaryInformationResponse | ::= | SEQUENCE { |

| | |
|---|---|
| SubsidiaryInformationResponse | SubsidiaryInformationResponse-IEs, |

}
SubsidiaryInformationResponse-IEs ::= SEQUENCE {

| | | |
|---|---|---|
| PC-Report | PC-Report-IEs | OPTIONAL, |

}

Referring to Table 13, a subsidiary information response information element includes a power coordination response (PC-Report) field. The subsidiary information response information element is transmitted when a UE receives subsidiary information request information including a power coordination request field.

Table 14 shows an example in which subsidiary information to respond to includes characteristic information about a hardware construction and information about power coordination.

TABLE 14

| | | |
|---|---|---|
| SubsidiaryInformationResponse | ::= | SEQUENCE { |

| | |
|---|---|
| SubsidiaryInformationResponse | SubsidiaryInformationResponse-IEs, |

}
SubsidiaryInformationResponse-IEs ::= SEQUENCE {

| | |
|---|---|
| No of RF chain | INTEGER (1..maxRF), |
| CI-Report | SEQUENCE (SIZE (1..maxRF)) OF SEQUENCE { |

Center Freqeuncy,
Bandwidth

| } | | OPTIONAL, |
|---|---|---|
| PC-Report | PC-Report-IEs | OPTIONAL, |

}

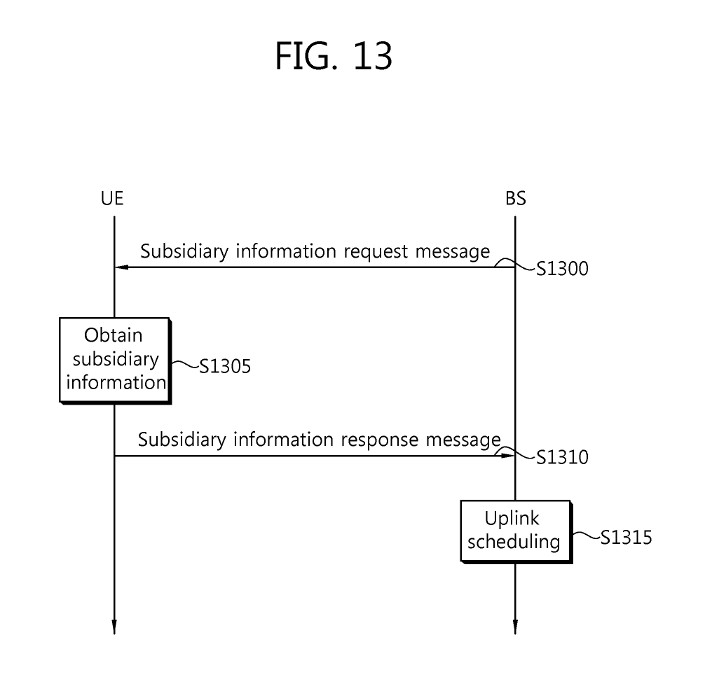

FIG. 13 shows a flow illustrating a method of transmitting control information about power coordination according to an exemplary embodiment.

Referring to FIG. 13, a BS transmits a subsidiary information request message to a UE at S1300. The subsidiary information request message includes a message to request subsidiary information from the UE and includes information fields, such as those shown in Table 9 to Table 11.

The UE obtains subsidiary information at S1305. Examples of the subsidiary information are described above. The subsidiary information may include characteristic information about the hardware construction of a UE or information about power coordination or both. For example, it may be assumed that the subsidiary information is characteristic information about the UE. The characteristic information, such as an RF chain, is handled in the level of the physical layer of the UE. Accordingly, the UE may obtain the characteristic information through signaling between a higher layer and the physical layer.

The UE transmits a subsidiary information response message, including the obtained subsidiary information, to the BS at S1310. The subsidiary information response message is a message for reporting the subsidiary information to the BS. The subsidiary information response message includes information fields, such as those shown in Table 12 to Table 13.

The BS extracts the subsidiary information from the subsidiary information response message and performs uplink scheduling on the basis of the extracted subsidiary information at S1315.

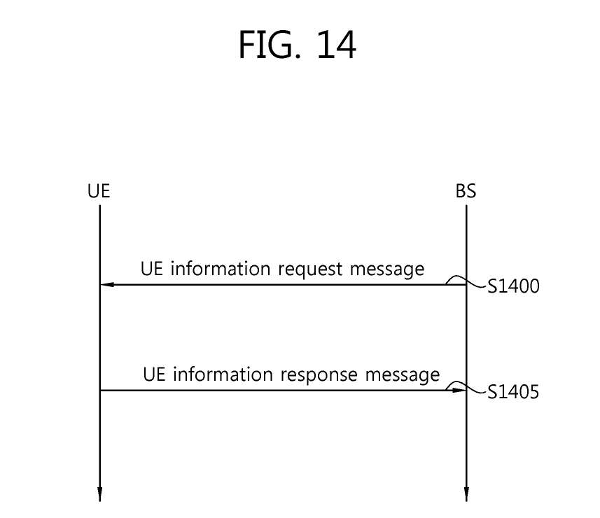

The UE and the BS may add the function of requesting and reporting subsidiary information to an existing RRC message, which is used for other purposes, without using additional subsidiary information request message and additional subsidiary information response message in order to exchange the subsidiary information. For example, the RRC message may be a UE information message. This is described with reference to FIG. 14 below.

FIG. 14 shows a flow illustrating a method of transmitting control information about power coordination according to an exemplary embodiment.

Specifically, FIG. 14 shows an example in which the transmission and reception of subsidiary information is performed by using a UE information procedure. The UE information procedure is a procedure of a UE transmitting all or some pieces of information, requested by a BS, to the BS when the BS requests all or some pieces of the information, from among information about a UE, information measured and obtained by the UE, and pieces of information pertinent to the operation of the UE, from the UE.

Referring to FIG. 14, a BS transmits a UE information request message, including a subsidiary information request information element, to a UE at S1400. The subsidiary information request information element includes the characteristic information request field of the UE or the power coordination request field of the UE or both. That is, the BS may insert a field, which requests characteristic information and/or information about power coordination, into the UE information request message. Table 15 shows an example of the UE information request field included in the UE information request message.

TABLE 15
UEInformationRequest field descriptions

CI-ReportReq
This field is used to indicate whether the UE shall report information about
the RF capability (e.g. supportable frequency bandwidth of each RF chain)
PC-ReportReq
This field is used to indicate whether the UE shall report information about
the PC (e.g. PC value, PC table, etc).

In response thereto, the UE transmits a UE information response message, including a subsidiary information response information element, to the BS at S1405. The subsidiary information response information element includes the characteristic information response field of the UE or the power coordination response field of the UE or both. Table 16 is an example of a description of the UE information response field that may be included in the UE information response message.

TABLE 16
UEInformationResponse field descriptions

UE-PowerClass
UE's PowerClass e.g. {PC2, PC3, PC4}
numberOfDLCCs
maximum number of DL CC supported by RF chain
numberOfULCCs
maximum number of UL CC supported by RF chain
Bandwidth
maxumum bandwidth supported by RF chain, e.g. {BW0 = 1.4, BW1 = 2.5,
BW2 = 5, BW3 = 10, BW4 = 15, BW5 = 20, BW6 = 40, BW7 = 100}
PC-Report
PC value or PC table index calculated based on current UE's
configuration

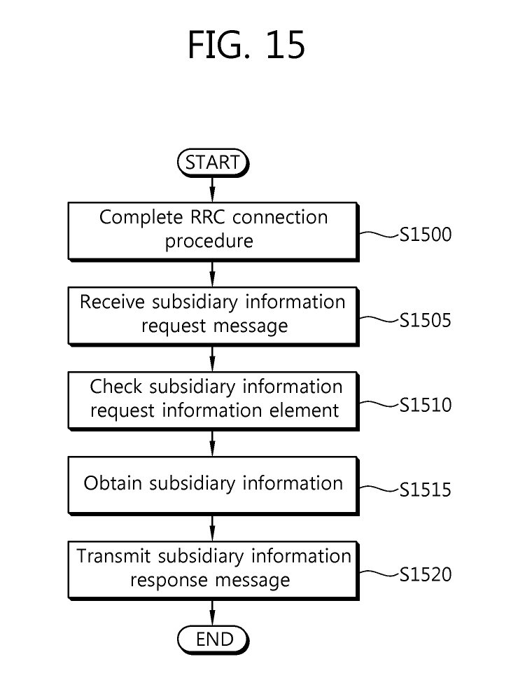

FIG. 15 is a flowchart illustrating a method of a mobile station transmitting control information about power coordination according to an exemplary embodiment. Here, it is assumed that a subsidiary information request message and a subsidiary information response message are RRC messages.

Referring to FIG. 15, the UE completes RRC connection procedures, such as an RRC connection establishment procedure, an RRC connection reestablishment procedure, and an RRC connection reconfiguration procedure, at S1500.

The UE receives a subsidiary information request message, including a subsidiary information request information element, from a BS at S1505.

The UE checks whether the characteristic information request field of the UE or the power coordination request field of the UE has been included in the subsidiary information request information element at S1510. If, as a result of the check, a field included in the subsidiary information request information element is a specific one (e.g., the characteristic information request field or the power coordination request field or both) and, if previously agreed upon between the UE and the BS, the field is not checked. Accordingly, the S1510 may be omitted.

The UE obtains subsidiary information (i.e., characteristic information and/or information about power coordination) and generates a subsidiary information response message including the subsidiary information at S1515. In a procedure of obtaining the subsidiary information, a higher layer of the UE may obtain the subsidiary information from a lower layer by requesting the subsidiary information from the lower layer, such as the physical layer. Accordingly, signaling between the higher layer and the lower layer may be performed in order to obtain the subsidiary information.

The UE transmit a subsidiary information response message to the BS at S1520.

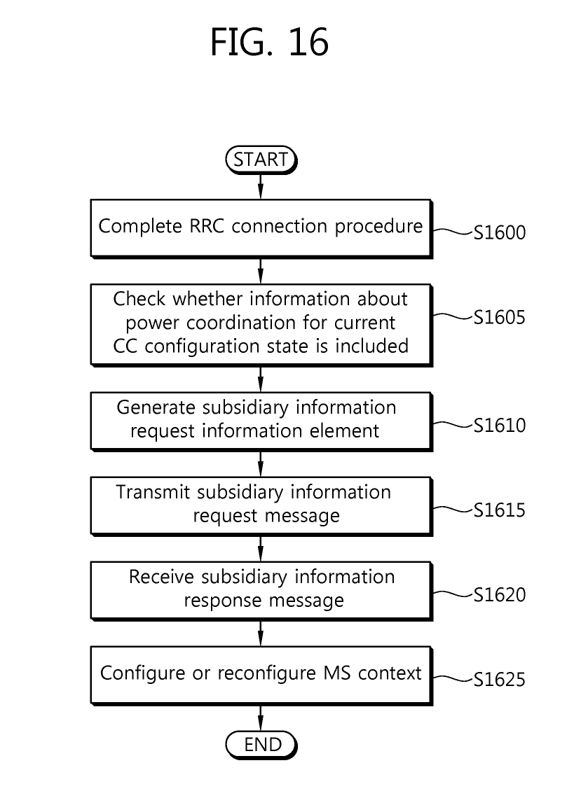

FIG. 16 is a flowchart illustrating a method of a base station transmitting control information about power coordination according to an exemplary embodiment.

Referring to FIG. 16, the BS completes RRC connection procedures, such as an RRC connection establishment procedure, an RRC connection reestablishment procedure, and an RRC connection reconfiguration procedure, at S1600.

The BS checks whether it has information about power coordination in relation to the current CC configuration state of a UE at S1605. Here, it is assumed that the BS has the information about power coordination. Although the BS has the information about power coordination, the procedure of FIG. 16 may not be disregarded, and the procedure S1605 may be performed again in order to obtain information about power coordination. Various combinations of the above described procedure may be implemented.

The BS determines subsidiary information and generates a subsidiary information request message including a subsidiary information request information element at S1610.

The BS transmits the subsidiary information request message to the UE at S1615.

The BS receives a subsidiary information response message from the UE as a response to the subsidiary information request message at S1620.

The BS extracts subsidiary information (i.e., characteristic information about the UE or information about power coordination or both) from the subsidiary information request message and constructs or reconstructs the context of the UE at S1625. This is because the context of the UE may be changed based on subsidiary information.

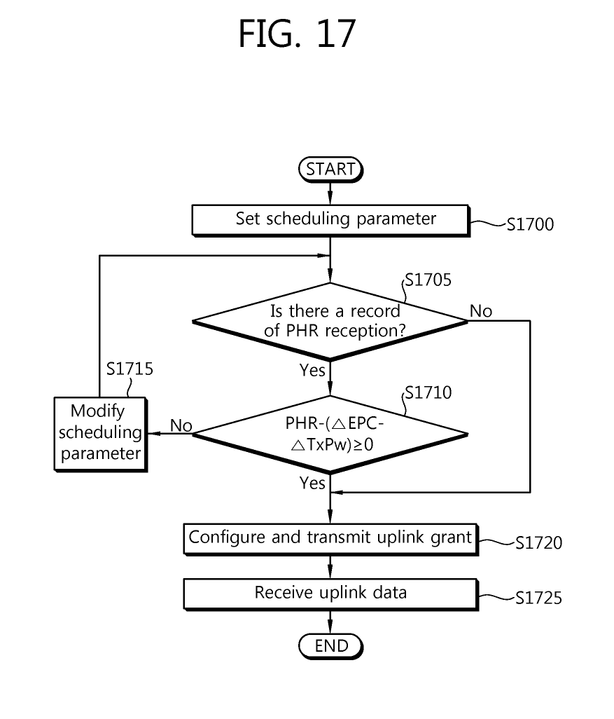

Subsequent operations are described in detail with reference to FIG. 17.

FIG. 17 is a flowchart illustrating a method of setting scheduling parameters based on information about power coordination according to an exemplary embodiment.

Referring to FIG. 17, a BS sets scheduling parameters, such as an MCS (Modulation and Coding Scheme), TPC (Transmit Power Control), and resource allocation information, by taking a Buffer State Report (BSR) received in uplink, a network condition, and a resource use condition into account at S1700.

The BS determines whether there is a record of a power headroom report (PHR) previously received at S1705. Here, a PH value according to the PHR is a PH value received most recently. Whether there is a record of the PHR received may be known through communication with a UE.

If, as a result of the determination, there is no record that the BS has received the PHR, a parameter related to scheduling, such as a PHR, is not taken into account when an uplink grant including a new data indicator (NDI) first transmitted is constructed. Accordingly, the BS configures the uplink grant based on the set scheduling parameters and sends the uplink grant to the UE at S1710.

If, as a result of the determination, there is a record that the BS has received the PHR, the BS determines scheduling validation at S1715. The determination of scheduling validation determines whether a changed scheduling parameter is valid from a viewpoint of an uplink maximum transmit power based on a PHR most recently received by the BS, if a scheduling parameter affecting the estimation value of power coordination is changed. An example in which scheduling validation is determined is shown in Equation 8 below.

PHR−(ΔEPC−ΔTxPw)≧0 [Equation 8]

Referring to Equation 8, ΔEPC is a value in which estimated power coordination (EPC) based on a previous scheduling parameter is subtracted from estimated power coordination (EPC) based on a current scheduling parameter. Scheduling parameters affecting the estimated power coordination (EPC) include the number of RBs, a modulation scheme, a PUSCH resource allocation format (i.e., whether PUSCH resources have been allocated contiguously or non-contiguously), and whether a PUCCH exists (i.e., whether a PUCCH and a PUSCH are transmitted in parallel or whether only a PUSCH is transmitted).

ΔTxPw is defined by the following relationship: ΔTxPw=ΔPUSCH+ΔPUCCH. Here, ΔPUCCH is taken into account in case of only a primary cell. ΔPUSCH is a value in which power of the PUSCH scheduled most recently has been subtracted from power of the PUSCH calculated according to a current scheduling parameter. ΔPUCCH is a value in which power of the PUCCH received most recently has been subtracted from power of the PUCCH to be received through a primary cell in a relevant subframe. Here, the PUCCH is received through the primary cell of a UE according to a cycle set by a BS for every UE. Accordingly, the BS may predict whether the PUCCH will be received according to a subframe.

In the case in which the scheduling validation is determined according to Equation 8, if Equation 8 is false (less than zero), the BS modifies the scheduling parameter according to its policy so that ΔEPC or ΔTxPw is reduced at S1715.

If Equation 8 is true, the set scheduling parameter is valid. Thus, the BS constructs an uplink grant on the basis of the set scheduling parameter and sends the uplink grant to the UE at S1720. The uplink grant is Downlink Control Information (DCI) of a format 0 for allocating uplink resources to the UE and is transmitted on a PDCCH. An example of the uplink grant is show in Table 17 below.

```
TABLE 17
Flag for format0/format1A differentiation—1 bit, where value 0 indicates format 0 and value 1 indicates
format 1A
Frequency hopping flag—1 bit
Resource block assignment and hopping resource allocation—┌log₂ (N_{RB}^{UL} (N_{RB}^{UL} + 1)/2)┐ bits
  For PUSCH hopping:
    N_{UL}_{_{—}}ₕₒₚ MSB bits are used to obtain the value of ñ_{PRB}(i)
    (┌log₂ (N_{RB}^{UL} (N_{RB}^{UL} + 1)/2)┐ − N_{UL}_{_{—}}ₕₒₚ) bits provide the resource allocation of the first slot in the
    UL subframe
  For non-hopping PUSCH:
    (┌log₂ (N_{RB}^{UL} (N_{RB}^{UL} + 1)/2)┐) bits provide the resource allocation in the UL subframe
Modulation and coding scheme and redundancy version—5 bits
New data indicator—1 bit
TPC command for scheduled PUSCH—2 bits
Cyclic shift for DM RS—3 bits
UL index—2 bits (this field is present only for TDD operation with uplink-downlink configuration 0)
Downlink Assignment Index (DAI)—2 bits (this field is present only for TDD operation with uplink-
downlink configurations 1-6)
CQI request—1 bit
Carrier Index Field (CIF)—3 bits (this field is present only for Carrier Aggregation)
```

Referring to Table 17, the uplink grant includes pieces of information, such as a RB, a modulation and coding scheme (MCS), and TPC. Next, the BS receives uplink data from the UE at S1725.

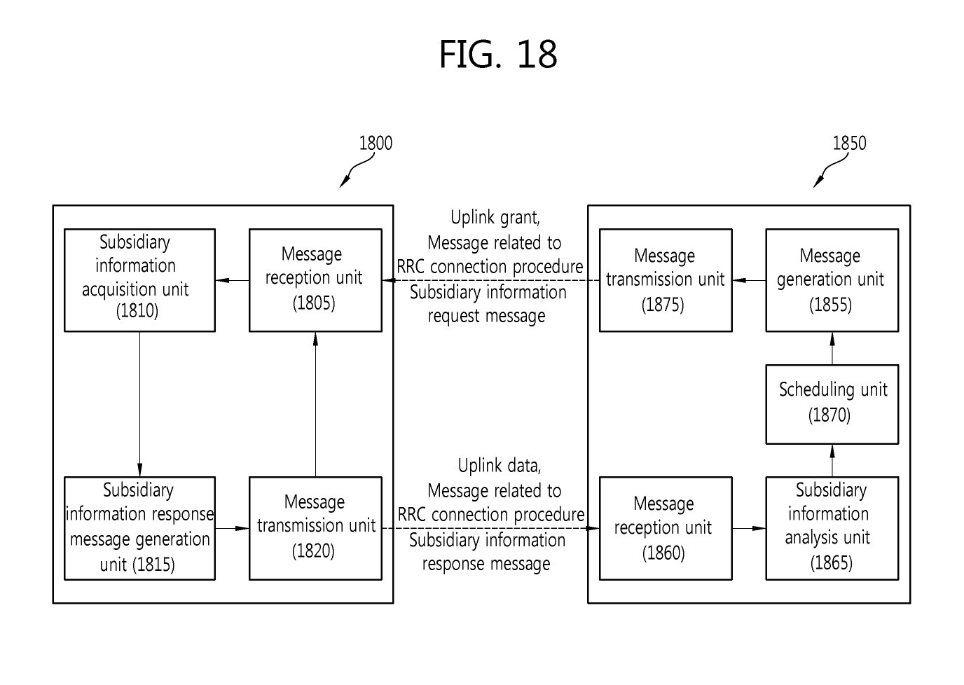

FIG. 18 is a block diagram showing a mobile station and a base station in a multiple component carrier system according to an exemplary embodiment.

Referring to FIG. 18, the multiple component carrier system includes the UE 1800 and the BS 1850. The UE 1800 includes a message reception unit 1805, a subsidiary information acquisition unit 1810, a subsidiary information response message generation unit 1815, and a message transmission unit 1820.

The message reception unit 1805 receives an uplink grant, a message related to RRC connection procedures and a subsidiary information request message from the BS 1850.

The subsidiary information acquisition unit 1810 extracts a subsidiary information request information element included in the subsidiary information request message and obtains subsidiary information complying with the request of the BS by analyzing a field included in the subsidiary information request information element. For example, if the subsidiary information request information element includes a characteristic information request field, the subsidiary information acquisition unit 1810 obtains characteristic information about the hardware construction of a UE. In this case, the subsidiary information acquisition unit 1810 may obtain the subsidiary information by requesting the subsidiary information from a lower layer that may provide the characteristic information. If the subsidiary information request information element includes a power coordination request field, the subsidiary information acquisition unit 1810 obtains information about the power coordination of a UE. Although an expression to ‘obtain’ the subsidiary information has been used, this has the same concept as an expression to ‘generate’ the subsidiary information.

The subsidiary information response message generation unit 1815 generates a subsidiary information response message including the subsidiary information obtained by the subsidiary information acquisition unit 1810. The subsidiary information response message may be a physical layer message, a MAC layer message, or a RRC layer message. Alternatively, the subsidiary information response message may be a UE information response message.

The message transmission unit 1820 transmits the subsidiary information response message, generated by the subsidiary information response message generation unit 1815, to the BS 1850. Alternatively, the message transmission unit 1820 transmits uplink data, generated based on the uplink grant, to the BS 1850.

The BS 1850 includes a message generation unit 1855, a message reception unit 1860, a subsidiary information analysis unit 1865, a scheduling unit 1870, and a message transmission unit 1875.

The message generation unit 1855 generates an uplink grant based on uplink scheduling parameters determined by the scheduling unit 1870. The message generation unit 1855 generates a subsidiary information request message for requesting subsidiary information. The subsidiary information request message may be a physical layer message, a MAC layer message, or a RRC layer message. Alternatively, the subsidiary information request message may be a UE information request message. The subsidiary information request message includes a subsidiary information request information element. The subsidiary information request information element includes a specific subsidiary information request field.

The message reception unit 1860 receives a subsidiary information response message, a message related to RRC connection procedures and uplink data from a UE.

The subsidiary information analysis unit 1865 analyzes the type of subsidiary information, by extracting the subsidiary information from the subsidiary information response message received by the message reception unit 1860. For example, the subsidiary information analysis unit 1865 determines whether the subsidiary information is characteristic information about the hardware construction of the UE 1800 or information about the power coordination of the UE 1800.

The scheduling unit 1870 may indirectly induce information about the power coordination based on the characteristic information analyzed by the subsidiary information analysis unit 1865. Alternatively, the scheduling unit 1870 may directly obtain the information about power coordination analyzed by the subsidiary information analysis unit 1865. The scheduling unit 1870 sets uplink scheduling parameters based on the obtained information about power coordination and informs the message generation unit 1855 of the uplink scheduling parameter.

The message transmission unit 1875 transmits an uplink grant, a message related to RRC connection procedures, and a subsidiary information request message to the UE 1800.

According to this disclosure, a BS can request information from a UE in order to obtain information about power coordination, and the UE transmits the information requested by the BS. Accordingly, a procedure of transmitting and receiving information about power coordination becomes clear. Further, compatibility with the existing systems procedures can be maintained because information about power coordination can be provided using the existing UE information procedure.

Various separate units for performing each procedure are described, but they are only illustrative. Each of the procedures may be performed by one unit (e.g., the processor of a UE or a BS).

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of transmitting control information in a multiple component carrier system, the method comprising:
receiving, at a user equipment (UE), a UE capability request message from a Base Station (BS); and
transmitting, at the UE, a UE capability response message, including UE characteristic information, to the BS,
wherein the UE characteristic information comprises information on the number of frequency bands simultaneously supportable by the UE, information on each of the frequency bands, information on a maximum number of component carriers supportable by the UE in each of the frequency bands, and information on a frequency bandwidth supportable by an aggregation within the maximum number of the component carriers.

2. The method of claim 1, wherein a total number calculated by adding the maximum number of the component carriers for all of the frequency bands, is smaller than or equal to a total number of component carriers supportable by the UE.

3. The method of claim 1, wherein the maximum number of the component carriers and the frequency bandwidth for each of the frequency bands, are determined by a hardware construction of the UE.

4. The method of claim 1, wherein an uplink band and a downlink band are subjected to frequency division within each of the frequency bands.

5. The method of claim 1, wherein the maximum number of the component carriers is determined within n(n≧1).

6. A method of receiving control information in a multiple component carrier system, the method comprising:
transmitting, at a Base Station (BS), a UE capability request message to a user equipment (UE); and
receiving, at the BS, a UE capability response message including UE characteristic information, from the UE,
wherein the UE characteristic information comprises information on the number of frequency bands simultaneously supportable by the UE, information on each the frequency bands, information on a maximum number of component carriers supportable by the UE in each of the frequency bands, and information on a frequency bandwidth supportable by an aggregation within the maximum number of the component carriers.

7. The method of claim 6, wherein a total number calculated by adding the maximum number of the component carriers for all of the frequency bands, is smaller than or equal to a total number of component carriers supportable by the UE.

8. The method of claim 6, wherein the maximum number of the component carriers and the frequency bandwidth for each of the frequency bands, are determined by a hardware construction of the UE.

9. The method of claim 6, wherein an uplink band and a downlink band are subjected to frequency division within each of the frequency bands.

10. The method of claim 6, wherein the maximum number of the component carriers in each of the frequency bands is determined within n(n1).

11. A user equipment (UE) to transmit control information in a multiple component system, the UE comprising:
a message reception unit configured to receive a UE capability request message from a Base Station (BS);
an information acquisition unit configured to analyze the UE capability request message and obtain UE characteristic information; and
a message transmission unit configured to transmit a UE capability response message including the UE characteristic information, to the BS,
wherein the UE characteristic information comprises information on the number of frequency bands simultaneously supportable by the UE, information on each the frequency bands, information on a maximum number of component carriers supportable by the UE in each of the frequency bands, and information on a frequency bandwidth supportable by an aggregation within the maximum number of the component carriers.

12. The UE as claimed in claim 11, wherein a total number calculated by adding the maximum number of the component carriers for all of the frequency bands, is smaller than or equal to a total number of component carriers supportable by the UE.

13. The UE as claimed in claim 11, wherein the maximum number of the component carriers and the frequency bandwidth for each of the frequency bands, are determined by a hardware construction of the UE.

14. The UE as claimed in claim 11, wherein an uplink band and a downlink band are subjected to frequency division within each of the frequency bands.

15. The UE as claimed in claim 11, wherein the maximum number of the component carriers in each of the frequency bands is determined within n(n1).

16. A base station (BS) to receive control information in a multiple component carrier system, the method comprising:
a message transmission unit configured to transmit, to a user equipment (UE), a UE capability request message;
a message reception unit configured to receive, from the UE, a UE capability response message including UE characteristic information, in response to the UE capability request message; and
a information analysis unit configured to determine the UE characteristic information,
wherein the UE characteristic information comprises information on the number of frequency bands simultaneously supportable by the UE, information on each the frequency bands, information on a maximum number of component carriers supportable by the UE in each of the frequency bands, and information on a frequency bandwidth supportable by an aggregation within the maximum number of the component carriers.

17. The BS as claimed in claim 16, wherein a total number calculated by adding the maximum number of the component carriers for all of the frequency bands, is smaller than or equal to a total number of component carriers supportable by the UE.

18. The BS as claimed in claim 16, wherein the maximum number of the component carriers and the frequency bandwidth for each of the frequency bands, are determined by a hardware construction of the UE.

19. The BS as claimed in claim 16, wherein an uplink band and a downlink band are subjected to frequency division within each of the frequency bands.

20. The BS as claimed in claim 16, wherein the maximum number of the component carriers for each of the frequency bands is determined within n(n1).

21. A method of transmitting control information in a multiple component carrier system, the method comprising:
receiving, at a user equipment (UE), a UE capability request message from a Base Station (BS); and
transmitting, at the UE, a UE capability response message, including UE characteristic information, to the BS,
wherein the UE characteristic information comprises information about a first frequency band supportable by the UE, information indicating a first maximum number of component carriers supportable by the UE in the first frequency band, and information about a first frequency bandwidth supportable by an aggregation of component carriers within the first maximum number, and
the UE characteristic information further comprises information about a second frequency band supportable by the UE, information indicating a second maximum number of component carriers supportable by the UE within the second frequency band, and information about a second frequency bandwidth supportable by an aggregation of component carriers within the second maximum number.

22. A method of receiving control information in a multiple component carrier system, the method comprising:
transmitting, at a Base Station (BS) a UE capability request message to a user equipment (UE); and
receiving, at the BS, a UE capability response message, including UE characteristic information, from the UE,
wherein the UE characteristic information comprises information about a first frequency band supportable by the UE, information indicating a first maximum number of component carriers supportable by the UE in the first frequency band, and information about a first frequency bandwidth supportable by an aggregation of component carriers within the first maximum number, and
the UE characteristic information further comprises information about a second frequency band supportable by the UE, information indicating a second maximum number of component carriers supportable by the UE within the second frequency band, and information about a second frequency bandwidth supportable by an aggregation of component carriers within the second maximum number.

23. A user equipment (UE) to transmit control information in a multiple component system, the UE comprising:
a message reception unit configured to receive, a UE capability request message from a Base Station (BS);
a information acquisition unit configured to obtain UE characteristic information; and
a message transmission unit configured to transmit, a UE capability response message, including the UE characteristic information, to the BS,
wherein the UE characteristic information comprises information about a first frequency band supportable by the UE, information indicating a first maximum number of component carriers supportable by the UE in the first frequency band, and information about a first frequency bandwidth supportable by an aggregation of component carriers within the first maximum number, and
the UE characteristic information further comprises information about a second frequency band supportable by the UE, information indicating a second maximum number of component carriers supportable by the UE within the second frequency band, and information about a second frequency bandwidth supportable by an aggregation of component carriers within the second maximum number.

24. A base station (BS) to receive control information in a multiple component carrier system, the method comprising:
a message transmission unit configured to transmitting, a UE capability request message to a user equipment (UE);
a message reception unit configured to receive, a UE capability response message, including UE characteristic information, from the UE; and
a information analysis unit configured to determine the UE characteristic information,
wherein the UE characteristic information comprises information about a first frequency band supportable by the UE, information indicating a first maximum number of component carriers supportable by the UE in the first frequency band, and information about a first frequency bandwidth supportable by an aggregation of component carriers within the first maximum number, and
the UE characteristic information further comprises information about a second frequency band supportable by the UE, information indicating a second maximum number of component carriers supportable by the UE within the second frequency band, and information about a second frequency bandwidth supportable by an aggregation of component carriers within the second maximum number.

25. A method of transmitting control information, in a multiple component carrier system, the method comprising:
receiving, at User Equipment (UE), a UE capability request message from a Base Station (BS); and
transmitting, at the UE, a UE capability response message, including a UE characteristic information set, to the BS,
wherein the UE characteristic information set comprises information about a frequency band supportable by the UE, information about a maximum number of component carriers supportable by the UE in the frequency band, and information about a frequency bandwidth supportable by an aggregation of component carriers within the maximum number of component carriers, and
the number of UE characteristic information sets equals to the number of frequency bands simultaneously supportable by the UE.

26. A method of receiving control information in a multiple component carrier system, the method comprising:
transmitting, at a Base Station (BS) a UE capability request message to a user equipment (UE); and
receiving, at the BS, a UE capability response message, including a UE characteristic information set, from the UE,
wherein the UE characteristic information set comprises information about a frequency band supportable by the UE, information about a maximum number of component carriers supportable by the UE in the frequency band, and information about a frequency bandwidth supportable by the UE through an aggregation of component carriers within the maximum number of component carriers, and
the number of UE characteristic information sets equals to the number of frequency bands simultaneously supportable by the UE.

27. A user equipment (UE) to transmit control information in a multiple component system, the UE comprising:
a message reception unit configured to receive, a UE capability request message from a Base Station (BS);
a information acquisition unit configured to obtain a UE characteristic information set; and
a message transmission unit configured to transmit, a UE capability response message, including the UE characteristic information set, to the BS,
wherein the UE characteristic information set comprises information about a frequency band supportable by the UE, information about a maximum number of component carriers supportable by the UE in the frequency band, and information about a frequency bandwidth supportable by an aggregation of component carriers within the maximum number of component carriers, and
the number of UE characteristic information sets equals to the number of frequency bands simultaneously supportable by the UE.

28. A base station (BS) to receive control information in a multiple component carrier system, the method comprising:
a message transmission unit configured to transmitting, a UE capability request message to a user equipment (UE);
a message reception unit configured to receive, a UE capability response message, including a UE characteristic information set, from the UE; and
a information analysis unit configured to determine the UE characteristic information set,
wherein the UE characteristic information set comprises information about a frequency band supportable by the UE, information about a maximum number of component carriers supportable by the UE in the frequency band, and information about a frequency bandwidth supportable by an aggregation of component carriers within the maximum number of component carriers, and
the number of UE characteristic information sets equals to the number of frequency bands simultaneously supportable by the UE.
